(19) United States
(12) Patent Application Publication
(10) Pub. No.: US 2023/0054488 A1
(43) Pub. Date: Feb. 23, 2023

(54) SOUNDING REFERENCE SIGNAL CONFIGURATION FOR AT LEAST TWO TRANSMISSION/RECEPTION POINTS

(71) Applicant: QUALCOMM Incorporated, San Diego, CA (US)

(72) Inventors: Alexandros MANOLAKOS, Escondido, CA (US); Muhammad Sayed Khairy ABDELGHAFFAR, San Jose, CA (US); Krishna Kiran MUKKAVILLI, San Diego, CA (US)

(21) Appl. No.: 17/759,508

(22) PCT Filed: Feb. 18, 2021
(86) PCT No.: PCT/US2021/018620

§ 371 Date: Jul. 26, 2022

(30) Foreign Application Priority Data
Feb. 21, 2020 (GR) 20200100093

(51) Int. Cl. H04L 5/00

(52) U.S. Cl. CPC H04L 5/0051; H04L 5/0035

(57) ABSTRACT

In an aspect of the disclosure, a method, a computer-readable medium, and an apparatus are provided. The apparatus may be a UE or a component thereof. The apparatus may be configured to receive a first downlink reference signal associated with a first TRP. The apparatus may be further configured to receive a second downlink reference signal associated with a second TRP. The apparatus may be further configured to transmit, to the first TRP and the second TRP, at least one sounding reference signal that is associated with both the first downlink reference signal and the second downlink reference signal.

### CROSS REFERENCE TO RELATED APPLICATION(S)

This application claims the benefit of Greek Patent Application Serial No. 20200100093, entitled “SOUNDING REFERENCE SIGNAL FOR MULTIPLE TRANSMISSION RECEPTION POINTS” and filed on Feb. 21, 2020, the disclosure of which is expressly incorporated by reference herein in its entirety.

### BACKGROUND

### Technical Field

The present disclosure generally relates to communication systems, and more particularly, to sounding designs for use with multiple transmission/reception points.

### Introduction

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In some access networks, user equipment (UE) may be used in some scenarios in which the UE is highly mobile—that is, the UE may be traveling at a high rate of speed, such as in a train, helicopter, automobile, etc., such that the geographic location of the UE may be changing relatively rapidly. For example, a UE be present on a train in which network access is available through high-speed train (HST) deployments (although other similar deployments are possible without departing from the scope of the present disclosure).

Even in HST deployments, the UE may communicate in a millimeter wave (mmW), near-mmW, and/or even centimeter wave (cmW) network. However, the rate at which the UE may be moving may introduce some characteristics to the channels on which the UE communicates that would otherwise be absent (or less severe) in non-HST scenarios. For example, high Doppler shifts, inter-carrier interference (ICI), inaccurate channel measurements, among other characteristics, may be exacerbated by the speed of the UE.

In order to mitigate at least some of the deleterious effects of a UE travelling at a high rate of speed, as on an HST, a wider and/or different bandwidth may be used for communication in the mmW spectrum, e.g., if a line-of-sight is available between the UE and at least one transmission/reception point (TRP). For example, a bandwidth (potentially wider) available on an mmW network may be used, such as with a single frequency network (SFN).

Regardless, the pathloss between a UE and a TRP may increase relatively rapidly in HST and similar scenarios, which may contribute to radio link failure at the UE. Pathloss and radio link failure may be mitigated through one or more of several different approaches.

For example, the UE may identify and configure quasi-colocation (QCL) and/or properties for some reference signals, such as demodulation reference signals (DMRS). Going further, downlink/uplink reciprocity may be observed, or even used to some degree, such as by applying one or more properties associated with QCL (or similar property) observed from one of a downlink signal or an uplink signal to the other of the uplink signal or downlink signal. For example, a set of transmission configuration indicator (TCI) states may be applied for uplink communication based on one or more properties detected from downlink communication using the same set of TCI states.

In many deployments, such as HST deployments, some use cases associated with various radio access technologies (e.g., 5G New Radio) may be expected to continue to operate with the same parameters commensurate with those use case. For example, ultra-reliable low-latency communication (URLLC) may be expected to provide certain block error rates and/or sub-millisecond latencies in HST deployments as in other deployments.

Potentially, latency may be reduced and/or reliability increased using multiple TRPs to simultaneously, contemporaneously, and/or consecutively communicate with a UE, e.g., for URLLC use cases. Illustratively, URLLC use cases with multi-TRPs may be scheduled by downlink control information (DCI) (e.g., at least one DCI message). Such DCI may carry information associated with schemes for multi-TRP communication scenarios.

In one scheme, each transmission occasion may be a layer or set of layers that is associated with the same transport block (TB), with each layer or layer set being further associated with one TCI (state) and/or one set of demodulation reference signal (DMRS) ports. A single codeword with one redundancy value (RV) may be used across all spatial layers or layer sets. As the UE communicates according to such a scheme, the UE may process different coded bits mapped to different layers or layer sets, e.g., according to a mapping configuration or definition.

In another scheme, each transmission occasion may be a layer or set of layers that is associated with the same TB, with each layer or layer set being further associated with one TCI (state) and/or one set of demodulation reference signal (DMRS) ports. A single codeword with one RV may be used for each spatial layer or layer set, and the respective RVs corresponding to each spatial layer or layer set may be the same or may be different.

In a further scheme, one transmission occasion is one layer of the same TB with one DMRS port associated with multiple TCI states (e.g., multiple indexes respectively corresponding to multiple TCI states) and/or one layer of the same TB with multiple DMRS ports associated with multiple TCI state indices one by one.

In some scenarios, SFN transmission from multi-TRPs with a single TCI state configured for a respective reference signal, such as a tracking reference signal (TRS), may be contemporaneously, or even simultaneously, transmitted by each of at least two coordinated TRPs. A UE may then be able to calculate a combined frequency offset based on the combined TRS.

In some other scenarios, a UE may be configured to estimate frequency offsets for at least two TRPs based on at least two indicated reference signals (e.g., TRSs) respectively received from the at least two TRPs. The UE may then calculate a proper frequency offset to compensate for channel estimation on at least one DMRS port. Thus, the UE may calculate a frequency offset per channel, and perform an optimized estimation of Doppler parameters on a “sparse” Doppler profile (e.g., a Doppler profile that is offset from a channel, frequency center, subcarrier, and so forth, a Doppler profile derived from one or more reference signals offset from a channel, frequency center, subcarrier, and so forth, etc.).

In some access networks, a UE may be configured to transmit on a PUSCH in a codebook-based and/or non-codebook-based manner. A UE may be configured with multiple sounding reference signal (SRS) resource sets, where the usage of each set can be set by RRC to at least one of “non-codebook transmission,” “codebook-based transmission,” “antenna switching,” and/or “beam management,” for example, according to capabilities of the UE.

In some instances of non-codebook based transmission (e.g., on an uplink data channel, such as a physical uplink shared channel (PUSCH)), a UE may be configured with one SRS resource set, e.g., configured with at most four SRS resources for non-codebook based uplink transmission.

If a UE is configured to transmit on a data channel (e.g., PUSCH) in a non-codebook based manner, an SRS resource indicator field in the uplink DCI may indicate a precoder and/or transmission rank associated with the SRS transmission.

In some other instances, a UE may be configured for transmission on a data channel (e.g., PUSCH) using a codebook, such as when a parameter (e.g., txConfig set to “codebook”). In some such other instances, once SRS resource set may be configured by/for the UE, with at least one property associated therewith (e.g., “usage”) set to correspond to codebook. The SRS resource set may include one, two, three, or four SRS resources, with the number of SRS ports being configured per SRS resource. Spatial relation information may be configured per SRS resource. For example, spatial relation information may indicate an index for a reference signal (e.g., channel state information (CSI) reference signal, synchronization signal block (SSB), other SRS resource, etc.) from which the UE is to derive a spatial domain filter (and/or precoding information). When the UE is to transmit an SRS on an SRS resource, the UE may apply the spatial domain filter or precoding information used for receiving the reference signal corresponding to the index indicated by the spatial relation information. For example, the UE may transmit an SRS using the same beam (or the same beam configuration) as that used for receiving the reference signal corresponding to the index indicated by the spatial relation information.

Further, one SRS resource (e.g., from the SRS resource set with usage associated with codebook-based transmission) may be indicated by the SRS resource indicator field of the DCI (e.g., format 0_1) scheduling the data channel (e.g., PUSCH). Information carried on the scheduled data channel may be received with a spatial domain filter or precoding information used (or to be used) for transmission of the SRS resource. For example, a set of properties for spatial domain transmission filtering and/or precoding may be shared (or may be in common) with a set of properties for spatial domain receive filtering and/or precoding for receiving the information on the scheduled data channel. In addition, the number of SRS ports of the indicated SRS resource may be used for a number of transmission antenna ports used for data channel transmission.

According to the present disclosure, at least one SRS resource may be associated with more than one reference signal (e.g., in the downlink) and/or two or more TCI states (e.g., each TCI state may be associated with one directionality in which one reference signal may be received of a set of N reference signals being transmitted with different directionalities), such as when the SRS resource is associated with codebook-based transmission on a data channel (e.g., PUSCH). In one aspect, a UE may contemporaneously transmit at least one respective SRS on each of N SRS ports in at least a portion of the same symbols, with each port using a spatial domain filter, precoding configuration, and/or transmit beam derived based on the N^{th} reference signal and/or TCI state. In another aspect, a UE may transmit an SRS on a single port per K symbols of an M-symbol SRS resource, such that the SRS is transmitted on each port using a spatial domain filter, precoding configuration, and/or transmit beam derived based on the N^{th} reference signal and/or TCI state.

In an aspect of the disclosure, a method, a computer-readable medium, and an apparatus are provided. The apparatus may be a UE or a component thereof. The apparatus may be configured to receive a first downlink reference signal associated with a first TRP. The apparatus may be further configured to receive a second downlink reference signal associated with a second TRP. The apparatus may be further configured to transmit, to the first TRP and the second TRP, at least one SRS that is associated with both the first downlink reference signal and the second downlink reference signal.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink channels within a subframe, in accordance with various aspects of the present disclosure.

FIG. 3 is a diagram illustrating an example of a base station and user equipment (UE) in an access network.

FIG. 4 is a diagram illustrating a single frequency network (SFN) with multiple transmission reception points (TRPs).

FIG. 5 is a communication flow diagram illustrating a transparent SFN.

FIG. 6 is a communication flow diagram illustrating a rank one data channel transmitted by an SFN.

FIG. 7 is a communication flow diagram illustrating a rank two data channel transmitted by an SFN.

FIG. 8 is a communication flow diagram illustrating at least one sounding reference signal (SRS) transmitted to multiple TRPs of an SFN.

FIG. 9 is a diagram illustrating symbols of an SRS resource.

FIG. 10 is a diagram illustrating symbols of an SRS resource.

FIG. 11 is a diagram illustrating symbols of an SRS resource in a first slot and symbols of an SRS resource in a second slot.

FIG. 12 is a diagram illustrating symbols of an SRS resource in a first slot and symbols of an SRS resource in a second slot.

FIG. 13 is a diagram illustrating symbols of an SRS resource in a first slot, symbols of an SRS resource in a second slot, and symbols of an SRS resource in a third slot.

FIG. 14 is a communication flow diagram 1400 illustrating an SRS transmitted to multiple TRPs of an SFN on an SRS resource set.

FIG. 15 is a communication flow diagram illustrating an SRS transmitted to multiple TRPs of an SFN on an SRS resource set.

FIG. 16 is a diagram illustrating symbols of an SRS resource of an SRS resource set.

FIG. 17 is a diagram illustrating symbols of an SRS resource of an SRS resource set.

FIG. 18 is a communication flow diagram illustrating an SRS transmitted to multiple TRPs of an SFN on an SRS resource set.

FIG. 19 is a flowchart of a method of wireless communication.

FIG. 20 is a diagram illustrating an example of a hardware implementation for an example apparatus.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, computer-executable code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or computer-executable code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer-executable code in the form of instructions or data structures that can be accessed by a computer.

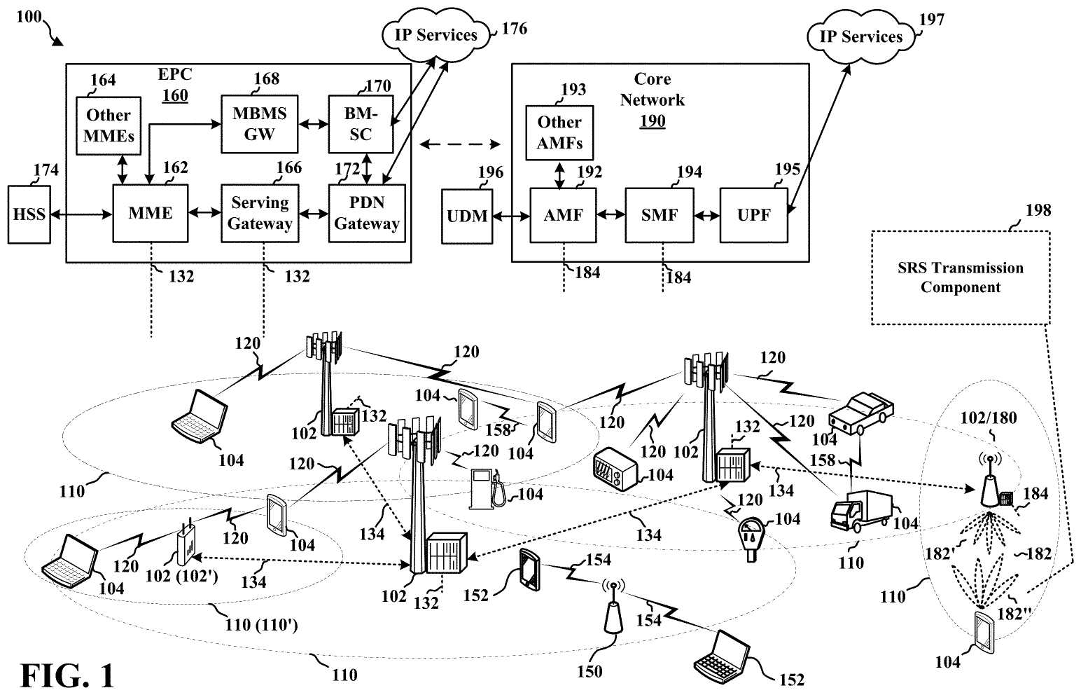

FIG. 1 is a diagram illustrating an example of a wireless communications system and an access network 100. The wireless communications system (also referred to as a wireless wide area network (WWAN)) includes base stations 102, user equipment(s) (UE) 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G Long Term Evolution (LTE) (collectively referred to as Evolved Universal Mobile Telecommunications System (UMTS) Terrestrial Radio Access Network (E-UTRAN)) may interface with the EPC 160 through first backhaul links 132 (e.g., S1 interface). The base stations 102 configured for 5G New Radio (NR) (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, Multimedia Broadcast Multicast Service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y megahertz (MHz) (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154, e.g., in a 5 gigahertz (GHz) unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHz, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). The frequencies between FR1 and FR2 are often referred to as mid-band frequencies. Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, or may be within the EHF band.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHz spectrum, in millimeter wave frequencies, and/or near millimeter wave frequencies in communication with the UE 104. When the gNB 180 operates in millimeter wave or near millimeter wave frequencies, the gNB 180 may be referred to as a millimeter wave base station. The millimeter wave base station 180 may utilize beamforming 182 with the UE 104 to compensate for the path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, an MBMS Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a Packet Switch (PS) Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides Quality of Service (QoS) flow and session management. All user IP packets are transferred through the UPF 195. The UPF 195 provides UE IP address allocation as well as other functions. The UPF 195 is connected to the IP Services 197. The IP Services 197 may include the Internet, an intranet, an IMS, a PS Streaming Service, and/or other IP services.

The base station may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Although the present disclosure may focus on 5G NR, the concepts and various aspects described herein may be applicable to other similar areas, such as LTE, LTE-Advanced (LTE-A), Code Division Multiple Access (CDMA), Global System for Mobile communications (GSM), or other wireless/radio access technologies.

Referring again to FIG. 1, in certain aspects, the UE 104 may be configured with a sounding reference signal (SRS) transmission component 198. The UE 104, e.g., using the SRS transmission component 198, may be further configured to receive a first downlink reference signal associated with a first TRP (e.g., one of the base stations 102/180); receive a second downlink reference signal associated with a second TRP (e.g., another of the base stations 102/180); and transmit, to the first TRP and the second TRP, at least one SRS that is associated with both the first downlink reference signal and the second downlink reference signal.

In some RANs, including various 5G NR RANs, a base station (e.g., gNB) may estimate at least one channel on which transmissions are received from a UE 104 (e.g., an uplink channel) using at least one SRS. Additionally or alternatively, SRS can be used for uplink frequency selective scheduling and/or uplink timing estimation.

Accordingly, the UE 104 transmits the at least one SRS to the base station. In so doing, the UE may sound all ports of an SRS resource in each symbol of the SRS resource. In some aspects, the UE may aperiodically transmit SRSs to the base station, with such aperiodic SRS transmission being triggered by the base station, for example, via downlink or uplink DCI (e.g., SRS request field).

For FDD (e.g., paired spectrum), the base station may utilize SRS to derive frequency domain-spatial domain (FD-SD) bases for precoding of CSI-RSs. However, if SRS is sounded per band, such as with SRS frequency hopping, the base station may be unable to combine frequency domain (FD) bases determined via SRS measurement. Similarly, in TDD, the base station may be unable to perform joint processing (e.g., noise filtering) using the channel impulse response (CIR) of two or more sub-bands.

Thus, a need exists for facilitating derivation of FD bases determined via SRS measurement by a base station. The present disclosure provides various techniques and solutions to the derivation of FD bases determined via SRS measurement by a base station. In particular, the present disclosure describes configuring a UE with two SRS resource allocations for each SRS resource of an SRS resource set, with each resource allocation including a resource allocation for both time and frequency. A first resource allocation of the at least two resource allocations may be based on sub-band sounding, and therefore, may include frequency hopping in the frequency resource allocation.

A second resource allocation of the at least two resource allocations, however, may be based on wideband sounding, and therefore, may exclude frequency hopping in the frequency resource allocation. Potentially, the base station may be able to combine FD bases determined via SRS measurement when the UE 104 is configured to transmit SRS for wideband sounding. Thus, the UE may (dynamically) select the aforementioned second resource allocation, for wideband sounding over all ports. Such (dynamic) selection of a resource allocation may be configured for the UE by the base station, e.g., as further described herein.

In some further aspects, the present disclosure describes the at least two resource allocations having different frequency comb configurations in respective frequency resource allocations. The difference between frequency comb configurations of the frequency resource allocations of the at least two resource allocations may increase SRS capacity, such as when the base station configures a relatively larger comb size for wideband sounding.

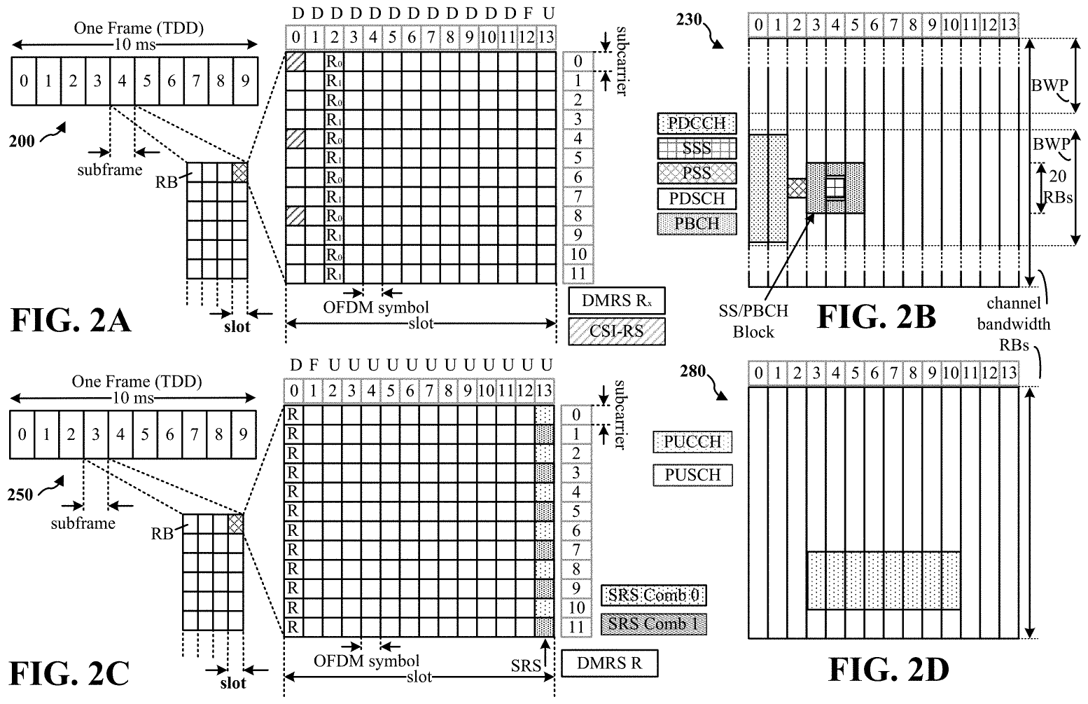

FIG. 2A is a diagram 200 illustrating an example of a first subframe within a 5G NR frame structure. FIG. 2B is a diagram 230 illustrating an example of downlink channels within a 5G NR subframe. FIG. 2C is a diagram 250 illustrating an example of a second subframe within a 5G NR frame structure. FIG. 2D is a diagram 280 illustrating an example of uplink channels within a 5G NR subframe. The 5G NR frame structure may be frequency division duplexed (FDD) in which for a particular set of subcarriers (carrier system bandwidth), subframes within the set of subcarriers are dedicated for either downlink or uplink, or may be time division duplexed (TDD) in which for a particular set of subcarriers (carrier system bandwidth), subframes within the set of subcarriers are dedicated for both downlink and uplink. In the examples provided by FIGS. 2A, 2C, the 5G NR frame structure is assumed to be TDD, with subframe 4 being configured with slot format 28 (with mostly downlink), where D is downlink, U is uplink, and F is flexible for use between downlink/uplink, and subframe 3 being configured with slot format 34 (with mostly uplink). While subframes 3, 4 are shown with slot formats 34, 28, respectively, any particular subframe may be configured with any of the various available slot formats 0-61. Slot formats 0, 1 are all downlink, uplink, respectively. Other slot formats 2-61 include a mix of downlink, uplink, and flexible symbols. UEs are configured with the slot format (dynamically through downlink control information (DCI), or semi-statically/statically through radio resource control (RRC) signaling) through a received slot format indicator (SFI). Note that the description infra applies also to a 5G NR frame structure that is TDD.

Other wireless communication technologies may have a different frame structure and/or different channels. A frame, e.g., of 10 milliseconds (ms), may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on DL may be cyclic prefix (CP) orthogonal frequency-division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies μ 0 to 4 allow for 1, 2, 4, 8, and 16 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2^{μ} slots/subframe. The subcarrier spacing and symbol length/duration are a function of the numerology. The subcarrier spacing may be equal to 2^{μ}*15 kilohertz (kHz), where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 microseconds (μs). Within a set of frames, there may be one or more different bandwidth parts (BWPs) (see FIG. 2B) that are frequency division multiplexed. Each BWP may have a particular numerology.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry at least one pilot and/or reference signal (RS) for the UE. In some configurations, an RS may include at least one demodulation RS (DM-RS) (indicated as Rₓ for one particular configuration, where 100x is the port number, but other DM-RS configurations are possible) and/or at least one channel state information (CSI) RS (CSI-RS) for channel estimation at the UE. In some other configurations, an RS may additionally or alternatively include at least one beam measurement (or management) RS (BRS), at least one beam refinement RS (BRRS), and/or at least one phase tracking RS (PT-RS).

FIG. 2B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol. A PDCCH within one BWP may be referred to as a control resource set (CORESET). Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit at least one SRS. The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests (SRs), a channel quality indicator (CQI), a precoding matrix indicator (PMI), a rank indicator (RI), and hybrid automatic repeat request (HARQ) acknowledgement (ACK)/non-acknowledgement (NACK) feedback. The PUSCH carries data, and may additionally be used to carry a buffer status report (BSR), a power headroom report (PHR), and/or UCI.

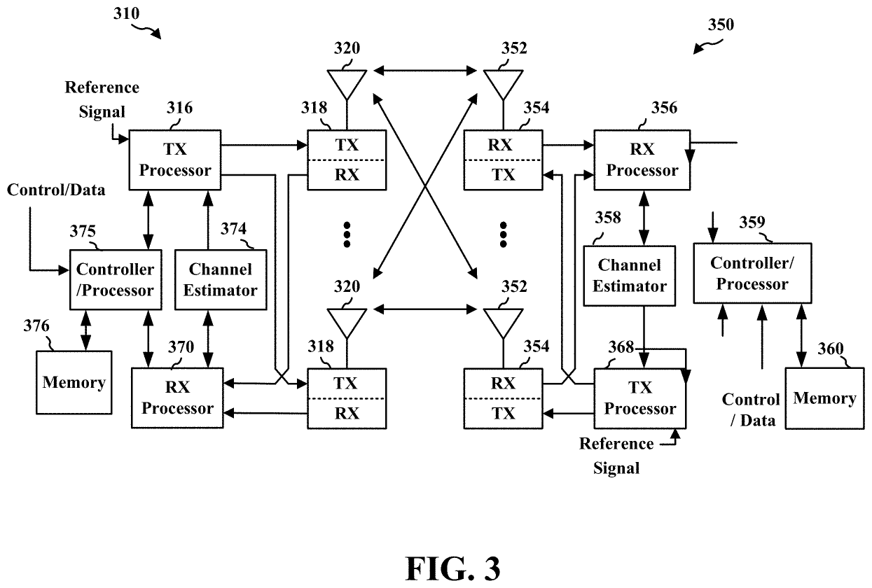

FIG. 3 is a block diagram of a base station 310 in communication with a UE 350 in an access network. In the DL, IP packets from the EPC 160 may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318TX. Each transmitter 318TX may modulate a radio frequency (RF) carrier with a respective spatial stream for transmission.

At the UE 350, each receiver 354RX receives a signal through its respective antenna 352. Each receiver 354RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the base station 310 in a manner similar to that described in connection with the receiver function at the UE 350. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 350. IP packets from the controller/processor 375 may be provided to the EPC 160. The controller/processor 375 is also responsible for error detection using an ACK and/or NACK protocol to support HARQ operations.

At least one of the TX processor 368, the RX processor 356, and the controller/processor 359 may be configured to perform aspects in connection with the SRS transmission component 198 of FIG. 1.

In some aspects, some access networks, UE may be used in some scenarios in which the UE is highly mobile—that is, the UE may be traveling at a high rate of speed, such as in a train, helicopter, automobile, etc., such that the geographic location of the UE may be changing relatively rapidly. For example, a UE be present on a train in which network access is available through high-speed train (HST) deployments (although other similar deployments are possible without departing from the scope of the present disclosure).

Even in HST deployments, the UE may communicate in a mmW, near-mmW, and/or even centimeter wave (cmW) network. However, the rate at which the UE may be moving may introduce some characteristics to the channels on which the UE communicates that would otherwise be absent (or less severe) in non-HST scenarios. For example, high Doppler shifts, inter-carrier interference (ICI), inaccurate channel measurements, among other characteristics, may be exacerbated by the speed of the UE.

In order to mitigate at least a subset of the deleterious effects of a UE travelling at a high velocity, as on an HST, a wider and/or different bandwidth may be used for communication in the mmW spectrum, e.g., if a line-of-sight is available between the UE and at least one TRP. For example, a bandwidth (potentially wider) available on an mmW network may be used, such as with a single frequency network (SFN).

Regardless, the pathloss between a UE and a TRP may increase relatively rapidly in HST and similar scenarios, which may contribute to radio link failure at the UE. Pathloss and radio link failure may be mitigated through one or more of several different approaches.

For example, the UE may identify and configure quasi-colocation (QCL) and/or properties for some reference signals, such as demodulation reference signals (DMRS). Going further, downlink/uplink reciprocity may be observed, or even used to some degree, such as by applying one or more properties associated with QCL (or similar property) observed from one of a downlink signal or an uplink signal to the other of the uplink signal or downlink signal. For example, a set of transmission configuration indicator (TCI) states may be applied for uplink communication based on one or more properties detected from downlink communication using the same set of TCI states.

In many deployments, such as HST deployments, some use cases associated with various radio access technologies (e.g., 5G New Radio) may be expected to continue to operate with the same parameters commensurate with those use case. For example, ultra-reliable low-latency communication (URLLC) may be expected to provide certain block error rates and/or sub-millisecond latencies in HST deployments as in other deployments.

Potentially, latency may be reduced and/or reliability increased using multiple TRPs to simultaneously, contemporaneously, and/or consecutively communicate with a UE, e.g., for URLLC use cases. Illustratively, URLLC use cases with multi-TRPs may be scheduled by DCI (e.g., at least one DCI message). Such DCI may carry information associated with schemes for multi-TRP communication scenarios.

In one scheme, each transmission occasion may be a layer or set of layers that is associated with the same TB, with each layer or layer set being further associated with one TCI (state) and/or one set of DMRS ports. A single codeword with one redundancy value (RV) may be used across all spatial layers or layer sets. As the UE communicates according to such a scheme, the UE may process different coded bits mapped to different layers or layer sets, e.g., according to a mapping configuration or definition.

In another scheme, each transmission occasion may be a layer or set of layers that is associated with the same TB, with each layer or layer set being further associated with one TCI (state) and/or one set of DMRS ports. A single codeword with one RV may be used for each spatial layer or layer set, and the respective RVs corresponding to each spatial layer or layer set may be the same or may be different.

In a further scheme, one transmission occasion is one layer of the same TB with one DMRS port associated with multiple TCI states (e.g., multiple indexes respectively corresponding to multiple TCI states) and/or one layer of the same TB with multiple DMRS ports associated with multiple TCI state indices one by one.

In some scenarios, SFN transmission from multi-TRPs with a single TCI state configured for a respective reference signal, such as a tracking reference signal (TRS), may be contemporaneously, or even simultaneously, transmitted by each of at least two coordinated TRPs. A UE may then be able to calculate a combined frequency offset based on the combined TRS.

In some other scenarios, a UE may be configured to estimate frequency offsets for at least two TRPs based on at least two indicated reference signals (e.g., TRSs) respectively received from the at least two TRPs. The UE may then calculate a proper frequency offset to compensate for channel estimation on at least one DMRS port. Thus, the UE may calculate a frequency offset per channel, and perform an optimized estimation of Doppler parameters on a “sparse” Doppler profile (e.g., a Doppler profile that is offset from a channel, frequency center, subcarrier, and so forth, a Doppler profile derived from one or more reference signals offset from a channel, frequency center, subcarrier, and so forth, etc.).

In some access networks, a UE may be configured to transmit on a PUSCH in a codebook-based and/or non-codebook-based manner. A UE may be configured with multiple SRS resource sets, where the usage of each set can be set by RRC to at least one of “non-codebook transmission,” “codebook-based transmission,” “antenna switching,” and/or “beam management,” for example, according to capabilities of the UE.

In some instances of non-codebook based transmission (e.g., on an uplink data channel, such as a PUSCH, a UE may be configured with one SRS resource set, e.g., configured with at most four SRS resources for non-codebook based uplink transmission.

If a UE is configured to transmit on a data channel (e.g., PUSCH) in a non-codebook based manner, an SRS resource indicator field in the uplink DCI may indicate a precoder and/or transmission rank associated with the SRS transmission.

In some other instances, a UE may be configured for transmission on a data channel (e.g., PUSCH) using a codebook, such as when a parameter (e.g., txConfig set to “codebook”). In some such other instances, once SRS resource set may be configured by/for the UE, with at least one property associated therewith (e.g., “usage”) set to correspond to codebook. The SRS resource set may include one, two, three, or four SRS resources, with the number of SRS ports being configured per SRS resource. Spatial relation information may be configured per SRS resource. For example, spatial relation information may indicate an index for a reference signal (e.g., channel state information (CSI) reference signal, synchronization signal block (SSB), other SRS resource, etc.) from which the UE is to derive a spatial domain filter (and/or precoding information). When the UE is to transmit an SRS on an SRS resource, the UE may apply the spatial domain filter or precoding information used for receiving the reference signal corresponding to the index indicated by the spatial relation information. For example, the UE may transmit an SRS using the same beam (or the same beam configuration) as that used for receiving the reference signal corresponding to the index indicated by the spatial relation information.

Further, one SRS resource (e.g., from the SRS resource set with usage associated with codebook-based transmission) may be indicated by the SRS resource indicator field of the DCI (e.g., format 0_1) scheduling the data channel (e.g., PUSCH). Information carried on the scheduled data channel may be received with a spatial domain filter and/or precoding information that is consistent with transmission of the SRS resource. For example, one or more properties for spatial domain transmission filtering and/or precoding may be shared (or may be in common) with one or more properties for spatial domain receive filtering and/or precoding for receiving the information on the scheduled data channel. In addition, the number of SRS ports of the indicated SRS resource may be used for a number of transmission antenna ports used for data channel transmission.

According to the present disclosure, at least one SRS resource may be associated with more than one reference signal (e.g., in the downlink) and/or two or more TCI states (e.g., each TCI state may be associated with one directionality in which one reference signal may be received of a set of N reference signals being transmitted with different directionalities), such as when the SRS resource is associated with codebook-based transmission on a data channel (e.g., PUSCH). In one aspect, a UE may contemporaneously transmit at least one respective SRS on each of N SRS ports in at least a portion of the same symbols, with each port using a spatial domain filter, precoding configuration, and/or transmit beam derived based on the N^{th} reference signal and/or TCI state. In another aspect, a UE may transmit an SRS on a single port per K symbols of an M-symbol SRS resource, such that the SRS is transmitted on each port using a spatial domain filter, precoding configuration, and/or transmit beam derived based on the N^{th} reference signal and/or TCI state.

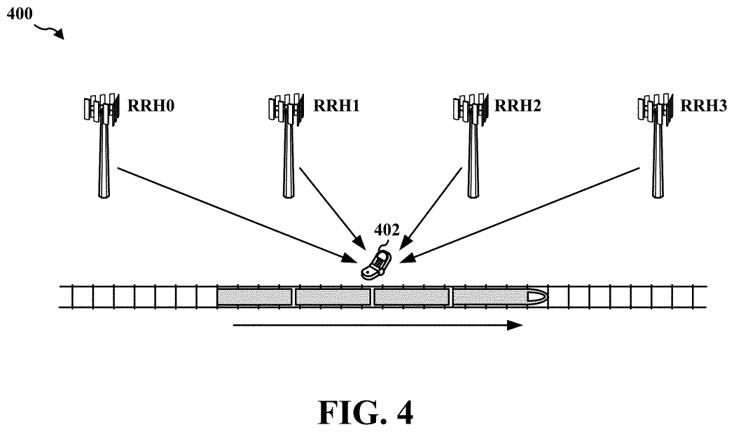

FIG. 4 a diagram 400 illustrating a single frequency network (SFN) with multiple TRPs. A SFN may include a number of transmission reception points for transmitting an SFN signal. For example, the SFN may include four remote radio heads (RRH): RRH0, RRH1, RRH2, and RRH3. Each RRH may be a TRP.

A UE 402 may connect to multiple TRPs in the SFN, e.g., may connect with the four nearest TRPs in the SFN. As illustrated in FIG. 4, the UE 402 is connected with RRH0, RRH1, RRH2, and RRH3. The TRPs connected to the UE 402 may all transmit an SFN signal to the UE 402 (e.g., the same signal) and the UE 402 may receive the SFN from each TRP or from some of the TRPs. As the UE 402 is receiving the SFN signal from multiple TRPs, the SFN signal received at the UE 402 may be influenced by a concatenation of the different channels between the UE 402 and the different TRPs.

The UE 402 may move relative to the TRPs. For example, as illustrated in FIG. 4, the UE 402 may be on a high speed train and the TRPs may be positioned periodically along the track for the high speed train. As the UE 402 moves, it may experience different channel conditions, such as different Doppler shifts and different path delays from the different TRPs. For example, the UE 402 may experience a positive Doppler shift for signals received from RRH2 which the UE 402 is moving toward and a negative Doppler shift for signals received from RRH1 which the UE 402 is moving away from.

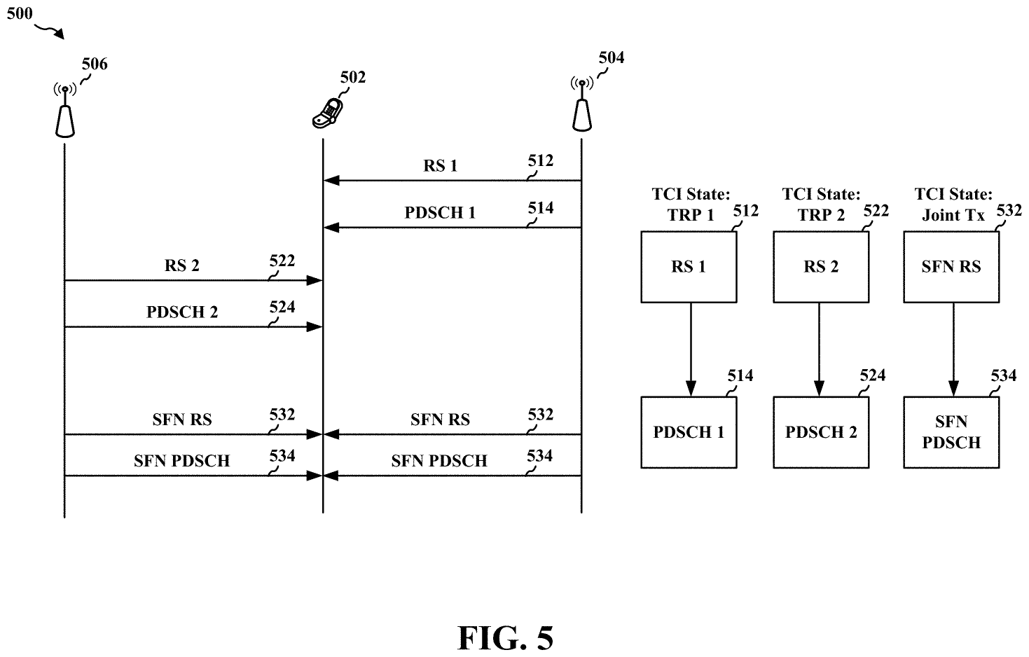

FIG. 5 is a communication flow diagram 500 illustrating a transparent SFN in which information is transmitted on data channels. A data channel may be a PDSCH. A UE 502 may be connected to a first TRP 504 and a second TRP 506. The first TRP 504 may transmit a first reference signal 512 to the UE 502. The second TRP 506 may transmit a second reference signal 522 to the UE 502.

The first TRP 504 may transmit a first PDSCH 514 to the UE 502. The first TRP 504 may transmit a transmission configuration indicator (TCI) state to the UE 502 for the first PDSCH 514 (e.g., in a PDCCH). The TCI state for the first PDSCH 514 may indicate that the first PDSCH 514 is associated with the first reference signal 512. For example, the TCI state may indicate a QCL relationship between the first PDSCH 514 and the first reference signal 512. Accordingly, the UE 502 may determine that the first PDSCH 514 is associated with the first reference signal 512 and estimate the channel for the first PDSCH 514 based on the first reference signal 512.

In some aspects, the first reference signal 512 may be associated with the first TRP 504 through a PCI or other similar identifier (ID) indicating that the first TRP 504 transmitted the first reference signal 512. The UE 502 may be able to determine that the first TRP 504 transmitted the first reference signal 512 according to the PCI or other similar ID. For example, the UE 502 may receive information from the first TRP 504 that explicitly indicates the association between the first reference signal 512 and the first TRP 504. In another example, the UE 502 may be able to determine that the first TRP 504 transmitted the first reference signal 512, and therefore is associated with the first TRP 504, according to QCL or a TCI state for receiving the first TRP 504. As such QCL or TCI state may each correspond to another reference or synchronization signal (e.g., SSB) received from the TRP 504, the UE 502 may infer the association between the first reference signal 512 and the first TRP 504.

The second TRP 506 may transmit to the UE 502 on a second PDSCH 524. The second TRP 506 may transmit a TCI state to the UE 502 for the second PDSCH 524 (e.g., in a PDCCH). The TCI state for the second PDSCH 524 may indicate that the second PDSCH 524 is associated with the second reference signal 522. For example, the TCI state may indicate a QCL relationship between the second PDSCH 524 and the second reference signal 522. Accordingly, the UE 502 may determine that the second PDSCH 524 is associated with the second reference signal 522 and estimate the channel for the second PDSCH 524 based on the second reference signal 522.

In some aspects, the second reference signal 522 may be associated with the second TRP 506 through a PCI or other similar ID indicating that the second TRP 506 transmitted the second reference signal 522. The UE 502 may be able to determine that the second TRP 506 transmitted the second reference signal 522 according to the PCI or other similar ID. For example, the UE 502 may receive information from the second TRP 506 that explicitly indicates the association between the second reference signal 522 and the second TRP 506. In another example, the UE 502 may be able to determine that the second TRP 506 transmitted the second reference signal 522, and therefore is associated with the second TRP 506, according to QCL or a TCI state for receiving the second TRP 506. As such QCL or TCI state may each correspond to another reference or synchronization signal (e.g., SSB) received from the TRP 504, the UE 502 may infer the association between the second reference signal 522 and the second TRP 506.

The first TRP 504 and the second TRP 506 may both transmit an SFN reference signal 532 to the UE 502. The SFN reference signal 532 may be a separate reference signal for use with signals transmitted over the SFN. The channel that UE 502 perceives for the SFN reference signal 532 may be a concatenation of the channel between the UE 502 and the first TRP 504 and the channel between the UE 502 and the second TRP 506. The first TRP 504 and the second TRP 506 may also both transmit an SFN PDSCH 534 to the UE 502. The TCI state for the SFN PDSCH 534 may indicate that the SFN PDSCH 534 is associated with the SFN reference signal 532. For example, the TCI state may indicate a QCL relationship between the SFN PDSCH 534 and the SFN reference signal 532. Accordingly, the UE 502 may determine that the SFN PDSCH 534 is associated with the SFN reference signal 532 and estimate the channel for the SFN PDSCH 534 based on the concatenated channel.

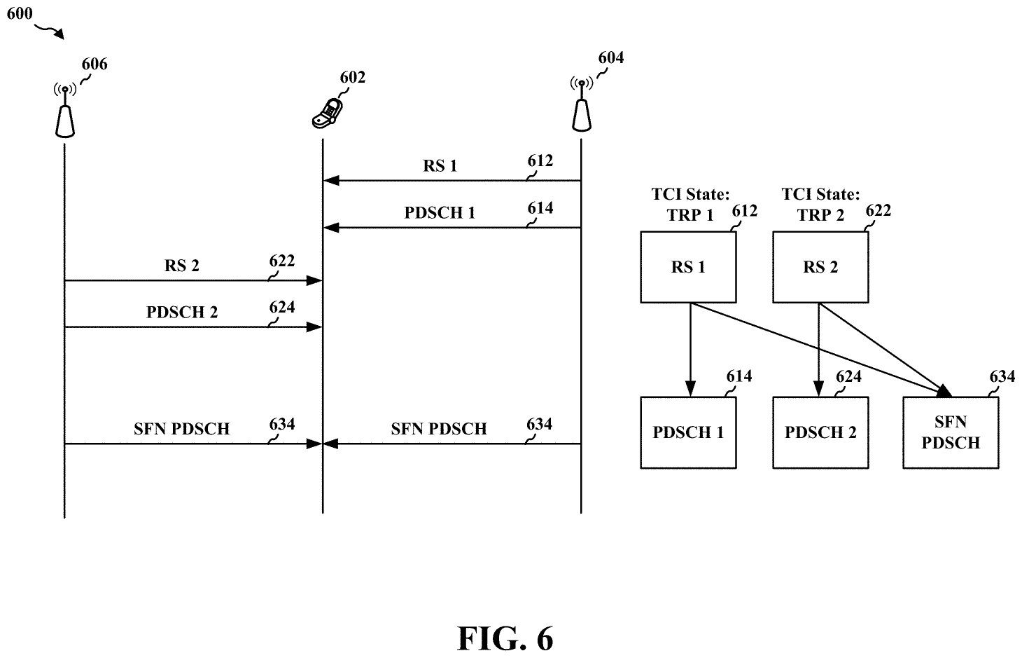

FIG. 6 is a communication flow diagram 600 illustrating a rank one data channel transmitted by an SFN. A data channel may be a PDSCH. A UE 602 may be connected to a first TRP 604 and a second TRP 606. The first TRP 604 may transmit a first reference signal 612 to the UE 602. The second TRP 606 may transmit a second reference signal 622 to the UE 602.

The first TRP 604 may transmit a first PDSCH 614 to the UE 602. The TCI state for the first PDSCH 614 may indicate that the first PDSCH 614 is associated with the first reference signal 612. The UE 602 may estimate the channel for the first PDSCH 614 based on the first reference signal 612.

The second TRP 606 may transmit a second PDSCH 624 to the UE 602. The TCI state for the second PDSCH 624 may indicate that the second PDSCH 624 is associated with the second reference signal 622. The UE 602 may estimate the channel for the second PDSCH 624 based on the second reference signal 622.

The first TRP 604 and the second TRP 606 may both transmit an SFN PDSCH 634 to the UE 602. The SFN PDSCH 634 may be rank 1 (e.g., may have one orthogonal layer). The SFN PDSCH 634 may have two TCI states associated with one port on which the SFN PDSCH 634 is received: one TCI state indicating that the SFN PDSCH 634 is associated with the first reference signal 612, and one TCI state indicating that the SFN PDSCH 634 is associated with the second reference signal 622. The UE 602 may estimate the channel for the SFN PDSCH 634 based on both the first reference signal 612 and the second reference signal 622. For example, the UE 602 may separately estimate a frequency offset or Doppler shift for the first TRP 604 based on the first reference signal 612 and estimate a frequency offset or Doppler shift for the second TRP 606 based on the second reference signal 622. The UE 602 may then calculate a frequency offset to compensate for channel estimation based on both estimates, or estimate the channel based on both Doppler shifts.

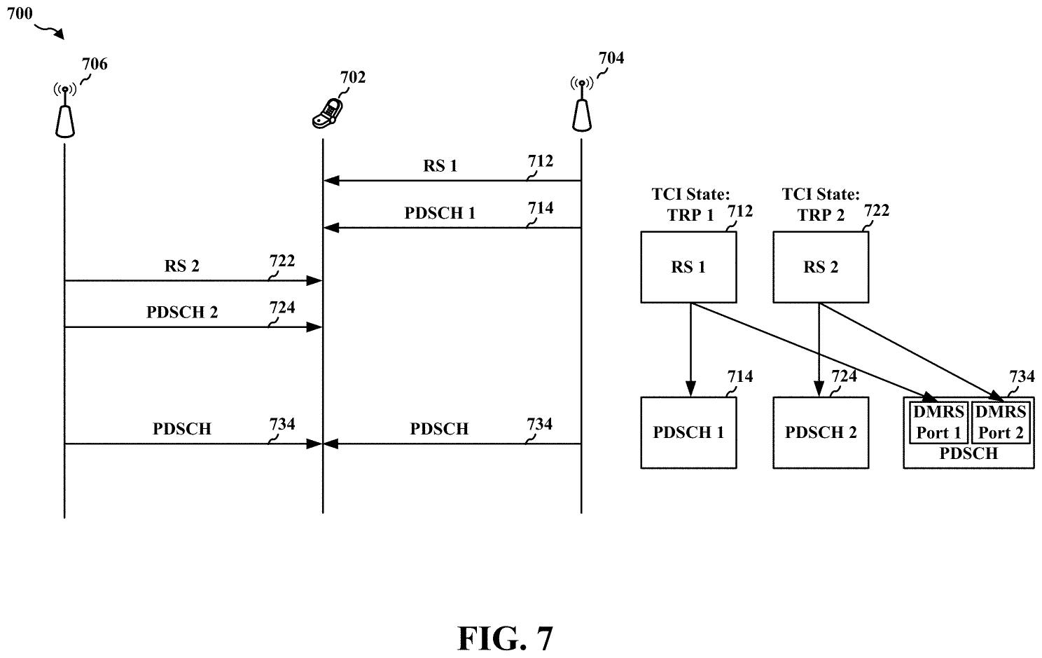

FIG. 7 is a communication flow diagram 700 illustrating a rank two PDSCH transmitted by an SFN. A UE 702 may be connected to a first TRP 704 and a second TRP 706. The first TRP 704 may transmit a first reference signal 712 to the UE 702. The second TRP 706 may transmit a second reference signal 722 to the UE 702.

The first TRP 704 may transmit a first PDSCH 714 to the UE 702. The TCI state for the first PDSCH 714 may indicate that the first PDSCH 714 is associated with the first reference signal 712. The UE 702 may estimate the channel for the first PDSCH 714 based on the first reference signal 712.

The second TRP 706 may transmit a second PDSCH 724 to the UE 702. The TCI state for the second PDSCH 724 may indicate that the second PDSCH 724 is associated with the second reference signal 722. The UE 702 may estimate the channel for the second PDSCH 724 based on the second reference signal 722.

The first TRP 704 and the second TRP 706 may both transmit a PDSCH 734 to the UE 702. The PDSCH 734 may be rank 2 (e.g., may have two orthogonal layers). The PDSCH 734 may have two DMRS ports. Each DMRS port may have a TCI state. The TCI state for the first DMRS port may indicate that the first DMRS port of the PDSCH 734 is associated with the first reference signal 712. The TCI state for the second DMRS port may indicate that the second DMRS port of the PDSCH 734 is associated with the second reference signal 722. The UE 702 may estimate the channel for the first port of the PDSCH 734 based on the first reference signal 712 and the may estimate the channel for the second port of the PDSCH 734 based on the second reference signal 722.

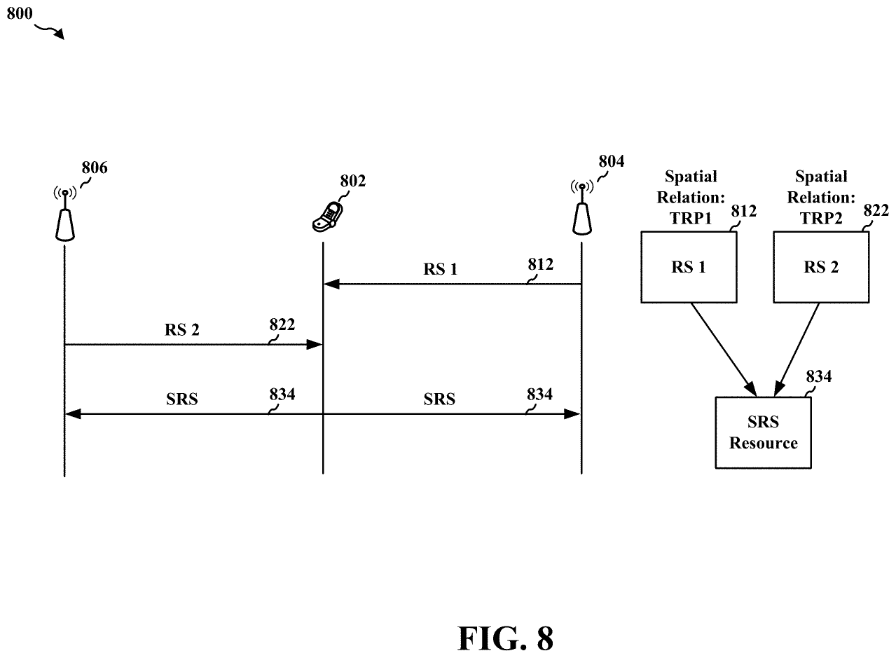

FIG. 8 is a communication flow diagram 800 illustrating SRS transmission by a UE 802 to multiple TRPs 804, 806 of an SFN. A UE may transmit an SRS to a TRP to enable the TRP to determine the channel between the UE and the TRP. An SRS may be transmitted on an SRS resource. In some aspects, an SRS resource may include a number of symbols. For example, an SRS resource may include two, four, six, eight, twelve, or fourteen symbols. In some aspects, an SRS resource may have one, two, three, or four ports.

A UE may be configured with one or more SRS resource set. A SRS resource set may be a set of SRS resources which the UE can use for a particular use case. A SRS resource set may have a usage such as codebook based transmission, non-codebook based transmission, antenna switching, or beam management. The usage of the SRS resource set may be configured by RRC.

An SRS resource may be configured with spatial relation information. The spatial relation information for the SRS resource may be used to determine one or more of a beam, spatial domain filtering, and/or a precoding configuration used for an SRS transmitted on the SRS resource (in some aspects, a “beam” may be at least partially defined through spatial domain filtering and/or precoding). For example, the spatial relation information may identify a reference signal, such as by an index indicated by the reference signal, and the UE may transmit the SRS on the SRS resource using a spatial domain filter, precoding configuration (e.g., precoding matrix), or beam that the UE may derive from receiving the identified reference signal. For example, the UE may apply one or more properties or values that the UE uses in receiving the identified reference signal to one or more properties or values that the UE uses for SRS transmission.

As illustrated in FIG. 8, a UE 802 may be connected to a first TRP 804 and a second TRP 806. The first TRP 804 may transmit a first reference signal 812 to the UE 802. The second TRP 806 may transmit a second reference signal 822 to the UE 802. In some aspects, the first reference signal 812 and the second reference signal 822 may be downlink reference signals. In some aspects, the first reference signal 812 may be the first reference signal 512 described above with respect to FIG. 5, the first reference signal 612 described above with respect to FIG. 6, or the first reference signal 712 described above with respect to FIG. 7. In some aspects, the second reference signal 822 may be the second reference signal 522 described above with respect to FIG. 5, the second reference signal 622 described above with respect to FIG. 6, or the second reference signal 722 described above with respect to FIG. 7.

The UE 802 may transmit an SRS 834 to the first TRP 804 and the second TRP 806. The SRS 834 may be associated with the first reference signal 812 and the second reference signal 822, with the reference signals 812, 822 each corresponding to a respective one of the TRPs 804, 806. Such association may be established according to one or more properties, such as QCL, TCI state, or spatial relation information. For example, the SRS 834 may be transmitted according to one or more properties that correspond (or are commonly used) with reception of at least one of the reference signals 812, 822. According to some aspects, an association between the SRS 834 and each of the at least two reference signals 812, 822 may be implicitly signaled. In some other aspects, an association between one of the at least two reference signals 812, 822 and the at least one SRS 834 may be explicitly configured for the UE 802 by a respective one of the TRPs 804, 806. For example, at least one of the TRPs 804, 806 may transmit association information to the UE 802 via at least one of DCI, MAC control element (CE), or other configuration information.

For example, the SRS 834 may be associated with a first TCI state, spatial domain filter, precoding information, and/or beam used for receiving the first reference signal 812, and the SRS 834 may be associated with a second TCI state, spatial domain filter, precoding information, and/or beam used for receiving the second reference signal 822. The first TCI state, spatial domain filter, precoding information, and/or beam may be based on the first reference signal 812, and the second TCI state, spatial domain filter, precoding information, and/or beam may be based on the second reference signal 822. In some aspects, each transmission by the UE 802 of the SRS 834 may use a respective one of at least two spatial domain filters, precoding configurations (e.g., two precoding matrices), and/or beams. Potentially, the first TCI state, spatial domain filter, precoding information, and/or beam and the second TCI state, spatial domain filter, precoding information, and/or beam may be the same or sufficiently alike such that the same TCI state, spatial domain filter, precoding information, and/or beam can be used for each transmission of the SRS 834 to a respective one of the TRPs 804, 806.

The UE 802 may transmit the SRS 834 on an SRS resource. The SRS resource may have multiple ports. In some aspects, the UE 802 transmits the SRS 834 on a first port of the SRS resource based on the first reference signal 812 and the UE 802 transmits the SRS 834 on a second port of the SRS resource based on the second reference signal 822. For example, the UE 802 may use at least one of first TCI state, spatial domain filter and/or precoding information, which may be based on the first reference signal 812, for SRS transmission on the SRS resource on the first port via a first beam, and the UE 802 may use least one of the second TCI state, spatial domain filter and/or precoding information, which may be based on the second reference signal 822, for SRS transmission on the second port of the SRS resource. The UE 802 may concurrently transmit the SRS 834 on the SRS resource on the ports, such that the SRS 834 is transmitted on a first port (e.g., using at least one of the first TCI state, spatial domain filter, and/or precoding information) to the first TRP 804 concurrently with transmission of the SRS 834 on a second port (e.g., using at least one of the second TCI state, spatial domain filter, and/or precoding information) to the second TRP 806.

In some aspects, the UE 802 may transmit the SRS 834 such that some symbols of the SRS resource are associated with (e.g., allocated or assigned to, scheduled for, etc.) the first reference signal 812 and/or some symbols of the SRS resource are associated with the second reference signal 822.

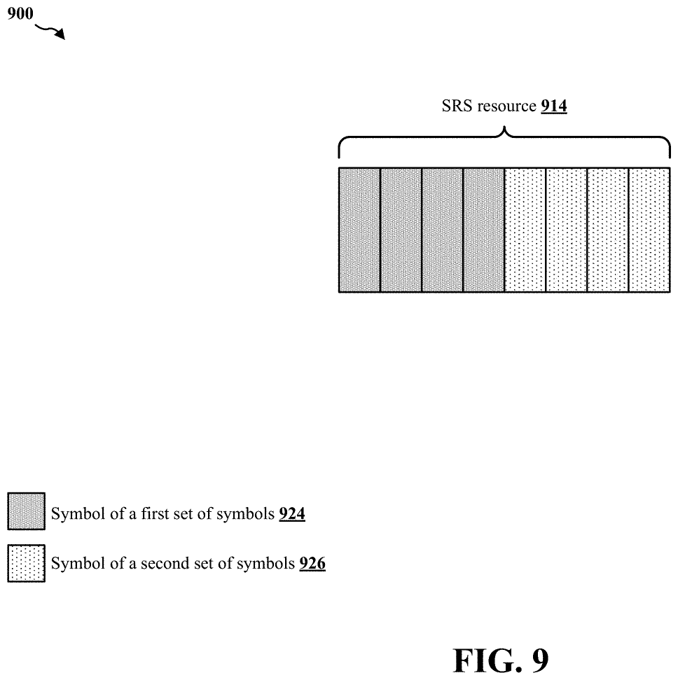

FIG. 9 is a diagram 900 illustrating sets of symbols 924, 926 of an SRS resource 914. In some aspects, an SRS may be transmitted on the SRS resource 914 on one (e.g., a single) port. To that end, the SRS resource 914 may be associated with the port, e.g., in that SRSs associated with the SRS resource 914 are assigned to be transmitted on the port. In the context of FIG. 8, the UE 802 may transmit the SRS 834 in a first set of symbols 924, which may be adjacent or contiguous symbols (e.g., symbols may be adjacent or contiguous if no intervening symbol occurs between those symbols). The UE 802 may configure the port on which the SRS 834 is to be transmitted on the SRS resource 914 based on reception of at least one reference signal from a TRP or other apparatus for which the UE 802 is sounding the channel. In some aspects, the UE 802 may configure the transmission of the SRS 834 on the first set of symbols 924 of the SRS resource 914 using a beam configuration that is based on reception of the first reference signal 812. For example, the UE 802 may configure a spatial domain filter, precoder, and/or beamforming property for transmission of the SRS 834 on the SRS resource 914 in the first set of symbols 924 based on a spatial domain filter, precoding information, and/or beamforming property applied at the UE 802 to receive the first reference signal 812.

Similarly, the UE 802 may transmit the SRS 834 in a second set of symbols 926 of the SRS resource 914 on the associated port. However, the UE 802 may configure transmission of the SRS 834 in the second set of symbols 926 to be different from that of the SRS 834 in the first set of symbols 924. using a beam configuration that is based on reception of the second reference signal 822. The first set of adjacent symbols and the second set of adjacent symbols may include the same number of symbols. For example, as illustrated in FIG. 9, the SRS resource 914 may have eight symbols. The UE 802 may transmit the SRS 834 using the beam configuration that is based on reception of the first reference signal 812 on the first four symbols, and may transmit the SRS 834 using the beam configuration that is based on reception of the second reference signal 822 on the second four symbols. As the SRS 834 symbols transmitted using one beam configuration may be adjacent (e.g., in time), they may be coherent.

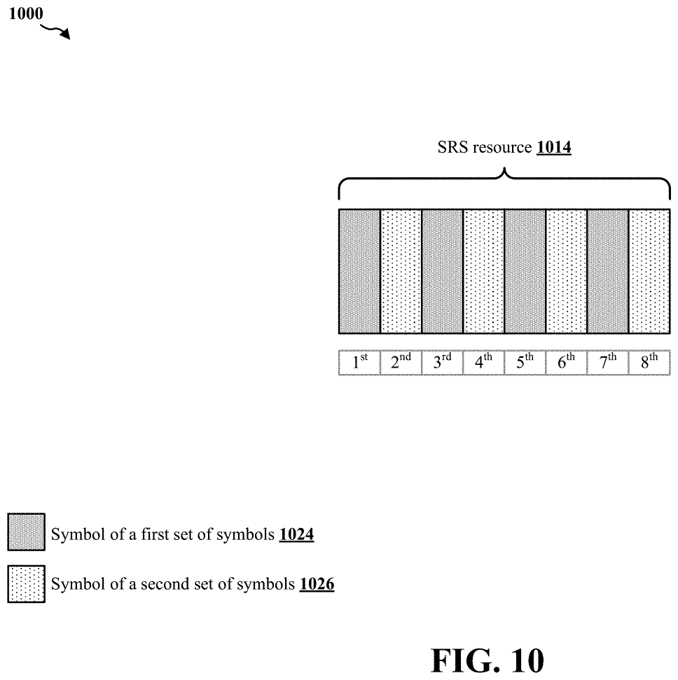

FIG. 10 is a diagram 1000 illustrating sets of symbols 1024, 1026 of an SRS resource 1014. In some aspects, an SRS may be transmitted on the SRS resource 1014 on one (e.g., a single) port, and therefore, the SRS resource 1014 may be associated with the port. In the context of FIG. 8, the UE 802 may transmit the SRS 834 in a first set of symbols 1024 and in a second set of symbols 1026. At least some of the symbols of each of the first and second sets of symbols 1024, 1026 may be nonadjacent or noncontiguous with symbols of the same set (e.g., symbols may be nonadjacent or noncontiguous if at least one intervening symbol occurs between those symbols). The first set of symbols 1024 and the second set of symbols 1026 may be interleaved.

The UE 802 may configure the port on which the SRS 834 is to be transmitted on the SRS resource 1014 based on reception of at least one reference signal from a TRP or other apparatus for which the UE 802 is sounding the channel. In some aspects, the UE 802 may transmit the SRS 834 in a first set of nonadjacent symbols 1024 of the SRS resource on the associated port using a configuration for at least one of a spatial domain filter, a precoder, beamforming, a beam, etc. that is based on reception of the first reference signal 812. Further, the UE 802 may transmit the SRS 834 in the second set of nonadjacent symbols 1026 of the SRS resource 1014 on the associated port using a configuration for at least one of a spatial domain filter, a precoder, beamforming, a beam, etc. that is based on reception of the second reference signal 822.

In some examples, the SRS resource 1014 may have eight symbols, which may be divided (e.g., evenly divided) into the first and second sets of symbols 1024, 1026. The UE 802 may transmit the SRS 834 on the first, third, fifth, and seventh symbols using the configuration that corresponds to (or is based upon) reception of the first reference signal 812. The UE 802 may transmit the SRS 834 on the second, fourth, sixth, and eighth symbols using the beam configuration corresponding to reception of the second reference signal 822. In some aspects, the UE 802 may transmit the SRS 834 using the beam corresponding to reception of the first reference signal 812 on the first, second, fifth, and sixth symbols, and may transmit the SRS 834 using the beam corresponding to reception of the second reference signal 822 on the third, fourth, seventh, and eighth symbols. As the SRS 834 is transmitted on a given beam across the time span of the SRS resource 1014, the SRS 834 may have more time domain diversity.

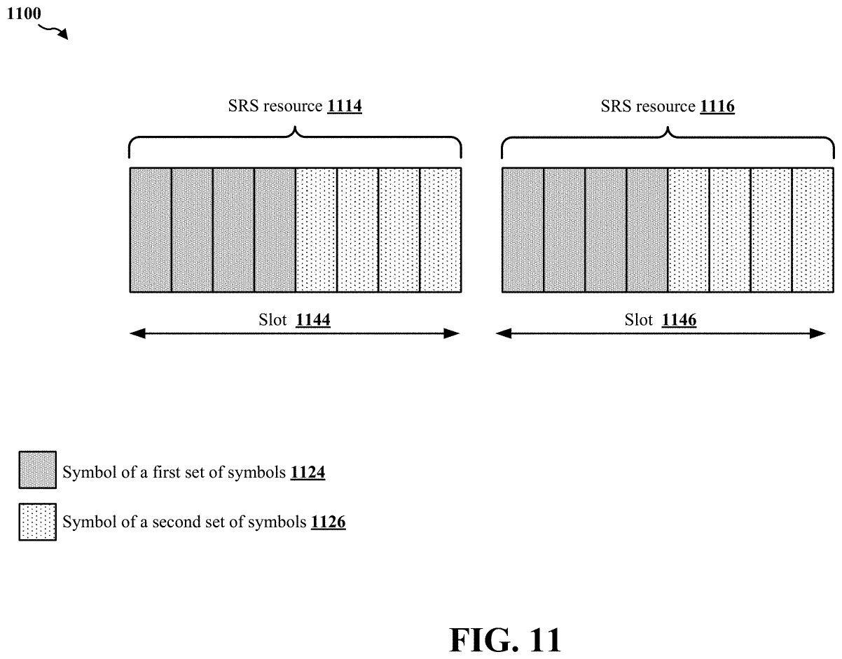

In some aspects, the UE 802 may transmit the SRS 834 on the SRS resource in multiple slots, and may transmit the SRS 834 using different beams on different symbols of the SRS resource in different slots. FIG. 11 is a diagram 1100 illustrating symbols of an SRS resource 1114 in a first slot 1144 and symbols of an SRS resource 1116 in a second slot 1146. The illustrated slots 1144, 1146 are intended to be illustrative and non-limiting, and therefore, SRS resources may have more or fewer symbols than shown in FIG. 11. In some aspects, each of the slots 1144, 1146 may include a different number of symbols than illustrated—e.g., each of the slots 1144, 1146 may include a set of seven or fourteen symbols, some of which may be excluded from SRS resources and/or may not be expressly illustrated by FIG. 11.

The first slot 1144 and the second slot 1146 may be adjacent slots (e.g., the first slot 1144 may be slot i and the second slot 1146 may be slot i+1), each having a respective first set of symbols 1124 and a respective second set of symbols 1126. The first SRS resource 1114 may include respective first and second sets of symbols 1124, 1126 of the first slot 1144, and the second SRS resource 1116 may include respective first and second sets of symbols 1124, 1126 of the second slot 1146.

In some aspects, the UE 802 may transmit the SRS 834 in a first set of symbols 1124 (e.g., the first four symbols) of the SRS resource 1114 in the first slot 1144 by configuring at least one of a spatial domain filter, precoder, beam, and/or beamforming property to correspond to (or to be based upon) a configuration and/or other property for reception of the first reference signal 812. For example, the UE 802 may generate or activate a transmit and/or uplink beam for transmission of the SRS 834 in the first set of symbols 1124 based on a configuration and/or other property of a receive or downlink beam used for receiving the first reference signal 812.

Similarly, the UE 802 may transmit the SRS 834 in a second set of symbols 1126 (e.g., the last four symbols) of the SRS resource 1114 in the first slot 1144 by configuring at least one of a spatial domain filter, precoder, beam, and/or beamforming property to correspond to (or to be based upon) a configuration and/or other property for reception of the second reference signal 822.

In the second slot 1146, the UE 802 may change (e.g., reverse) the order of the TRPs 804, 806 to which the SRS 834 is transmitted. Illustratively, the UE 802 may transmit the SRS 834 in the first set of symbols 1124 based on reception of the second reference signal 822 (e.g., so that the SRS 834 is transmitted to the second TRP 806), and the UE 802 may further transmit the SRS 834 in the second set of symbols 1126 based on reception of the first reference signal 812 (e.g., so that the SRS 834 is transmitted to the first TRP 804). For example, the UE 802 may transmit the SRS 834 in the second set of symbols 1126 (e.g., the last four symbols) of the SRS resource 1116 in the second slot 1146 using a beam corresponding to reception of the first reference signal 812, and may transmit the SRS 834 using a beam corresponding to reception of the second reference signal 822 in the first set of symbols (e.g., the first four symbols) of the SRS resource 1116 in the second slot 1146.

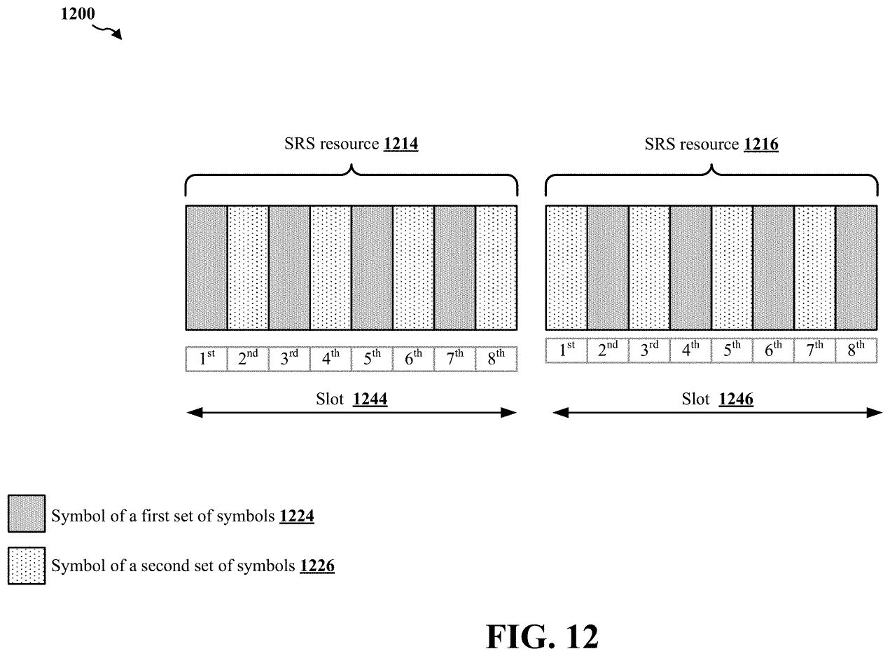

FIG. 12 is a diagram 1200 illustrating symbols 1224, 1226 of an SRS resource 1214 in a first slot 1244 and symbols 1224, 1226 of an SRS resource 1216 in a second slot 1246. The illustrated slots 1244, 1246 are intended to be illustrative and non-limiting, and therefore, SRS resources may have more or fewer symbols than shown in FIG. 12. In some aspects, each of the slots 1244, 1246 may include a different number of symbols than illustrated—e.g., each of the slots 1244, 1246 may include a set of seven or fourteen symbols, some of which may be excluded from SRS resources and/or may not be expressly illustrated by FIG. 12.

The first slot 1244 and the second slot 1246 may be adjacent slots (e.g., the first slot 1244 may be slot i and the second slot 1246 may be slot i+1), each having a respective first set of symbols 1224 and a respective second set of symbols 1226. The first SRS resource 1214 may include respective first and seconds sets of symbols 1224, 1226 of the first slot 1244, and similarly, the second SRS resource 1216 may include respective first and seconds sets of symbols 1224, 1226 of the second slot 1246.

In the context of FIG. 8, the UE 802 may transmit the SRS 834, for example, using a beam corresponding to reception of the first reference signal 812 in a first set of symbols 1224 (e.g., the first, third, fifth, and seventh symbols) in the first slot 1244. The UE 802 may further transmit the SRS 834 on the SRS resource 1214 in the second set of symbols 1226 (e.g., the second, fourth, sixth, and eighth symbols) in the first slot 1244 using a beam corresponding to reception of the second reference signal 822.

In addition, the UE 802 may transmit the SRS 834 on the SRS resource 1216 in the second set of symbols 1226 (e.g., the second, fourth, sixth, and eighth symbols) in the second slot 1246 using a beam corresponding to reception of the first reference signal 812. Further, the UE 802 may transmit the SRS 834 on the SRS resource 1216 in the first set of symbols 1224 (e.g., the first, third, fifth, and seventh symbols) in the second slot 1246 using a beam corresponding to reception of the second reference signal 822.

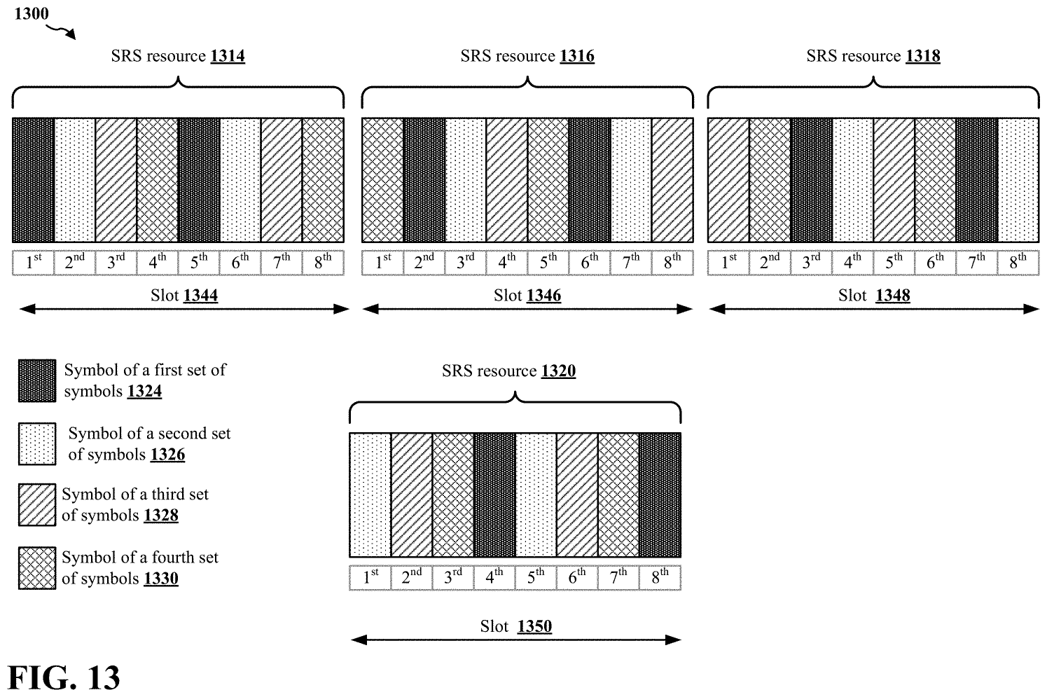

FIG. 13 is a diagram 1300 illustrating symbols of an SRS resource 1314 in a first slot 1344, symbols of an SRS resource 1316 in a second slot 1346, symbols of an SRS resource 1318 in a third slot 1348, and symbols of an SRS resource 1320 in a fourth slot 1350. The illustrated slots 1344, 1346, 1348, 1350 are intended to be illustrative and non-limiting, and therefore, SRS resources may have more or fewer symbols than shown in FIG. 13. In some aspects, each of the slots 1344, 1346, 1348, 1350 may include a different number of symbols than illustrated—e.g., each of the slots 1344, 1346, 1348, 1350 may include a set of seven or fourteen symbols, some of which may be excluded from SRS resources and/or may not be expressly illustrated by FIG. 13.

The slots 1344, 1346, 1348, 1350 may be adjacent slots (e.g., the first slot 1344 may be slot i, the second slot 1346 may be slot i+1, the third slot 1348 may be slot i+2, and the fourth slot 1350 may be slot i+3), each having a respective first set of symbols 1324, a respective second set of symbols 1326, a respective third set of symbols 1328, and a respective fourth set of symbols 1330. The sets of symbols 1324, 1326, 1328, 1330 may indicate positioning or indexing of a symbol within each of the slots 1344, 1346, 1348, 1350—e.g., according to the reference signal that SRS transmission is based.

In some aspects, the UE 802 may rotate which symbols are used for a given reference signal, such as in a round robin pattern. For example, a UE may receive first, second, third, and fourth downlink reference signals from first, second, third, and fourth TRPs. Using a beam corresponding to reception of the first reference signal, the UE may transmit SRSs in a first set of symbols 1324 in the first slot 1344 (e.g., the first and fifth symbols of the SRS resource 1314), in a second set of symbols 1326 in the second slot 1346 (e.g., the second and sixth symbols of the SRS resource 1316), in a third set of symbols 1328 in the third slot 1348 (e.g., the third and seventh symbols of the SRS resource 1318), and in a fourth set of symbols 1330 in the fourth slot 1350 (e.g., the fourth and eighth symbols of the SRS resource 1320).

Similarly, the UE may transmit, using a beam corresponding to reception of the second reference signal, SRSs in a second set of symbols 1326 in the first slot 1344 (e.g., the second and fifth symbols of the SRS resource 1314), in a third set of symbols 1328 in the second slot 1346 (e.g., the third and seventh symbols of the SRS resource 1316), in a fourth set of symbols 1330 in the third slot 1348 (e.g., the fourth and eighth symbols of the SRS resource 1318), and in a first set of symbols 1324 in the fourth slot 1350 (e.g., the first and fifth symbols of the SRS resource 1320).

Further, the UE may transmit, using a beam corresponding to reception of the third reference signal, SRSs in a third set of symbols 1328 in the first slot 1344 (e.g., the third and seventh symbols of the SRS resource 1314), in a fourth set of symbols 1330 in the second slot 1346 (e.g., the fourth and eighth symbols of the SRS resource 1316), and in a first set of symbols 1324 in the third slot 1348 (e.g., the first and fifth symbols of the SRS resource 1318), and in a second set of symbols 1326 in the fourth slot 1350 (e.g., the second and fifth symbols of the SRS resource 1320).

Correspondingly, the UE may transmit, using a beam corresponding to reception of the fourth reference signal, SRSs in a fourth set of symbols 1330 in the first slot 1344 (e.g., the fourth and eighth symbols of the SRS resource 1314), in a first set of symbols 1324 in the second slot 1346 (e.g., the first and fifth symbols of the SRS resource 1316), in a second set of symbols 1326 in the third slot 1348 (e.g., the second and fifth symbols of the SRS resource 1318), and in a third set of symbols 1328 in the fourth slot 1350 (e.g., the third and seventh symbols of the SRS resource 1320).

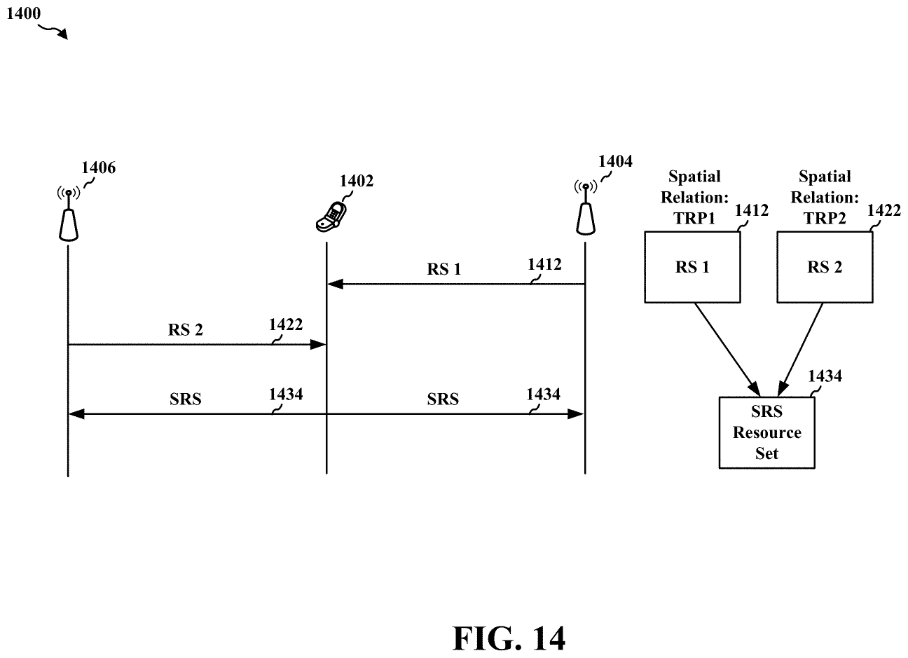

FIG. 14 is a communication flow diagram 1400 illustrating an SRS transmitted to multiple TRPs of an SFN on an SRS resource set. A UE 1402 may be connected to a first TRP 1404 and a second TRP 1406. The first TRP 1404 may transmit a first reference signal 1412 to the UE 1402. The second TRP 1406 may transmit a second reference signal 1422 to the UE 1402. In some aspects, the first reference signal 1412 and the second reference signal 1422 may be downlink reference signals. In some aspects, the first reference signal 1412 may be the first reference signal 512 described above with respect to FIG. 5, the first reference signal 612 described above with respect to FIG. 6, or the first reference signal 712 described above with respect to FIG. 7. In some aspects, the second reference signal 1422 may be the second reference signal 522 described above with respect to FIG. 5, the second reference signal 622 described above with respect to FIG. 6, or the second reference signal 722 described above with respect to FIG. 7.

The UE 1402 may transmit an SRS 1434 to the first TRP 1404 and the second TRP 1406 on an SRS resource set. For example, the SRS resource set may be configured for non-codebook based transmission. The SRS resource set may include multiple SRS resources. In some aspects, the UE 1402 may transmit the SRS 1434 on a first SRS resource of the SRS resource set based on the first reference signal 1412 and the UE 1402 may transmit the SRS 1434 on a second SRS resource of the SRS resource set based on the second reference signal 1422. For example, the UE 1402 may use the beam corresponding to reception of the first reference signal 1412 for the first SRS resource, and the UE 1402 may use the beam corresponding to reception of the second reference signal 1422 for the second SRS resource.

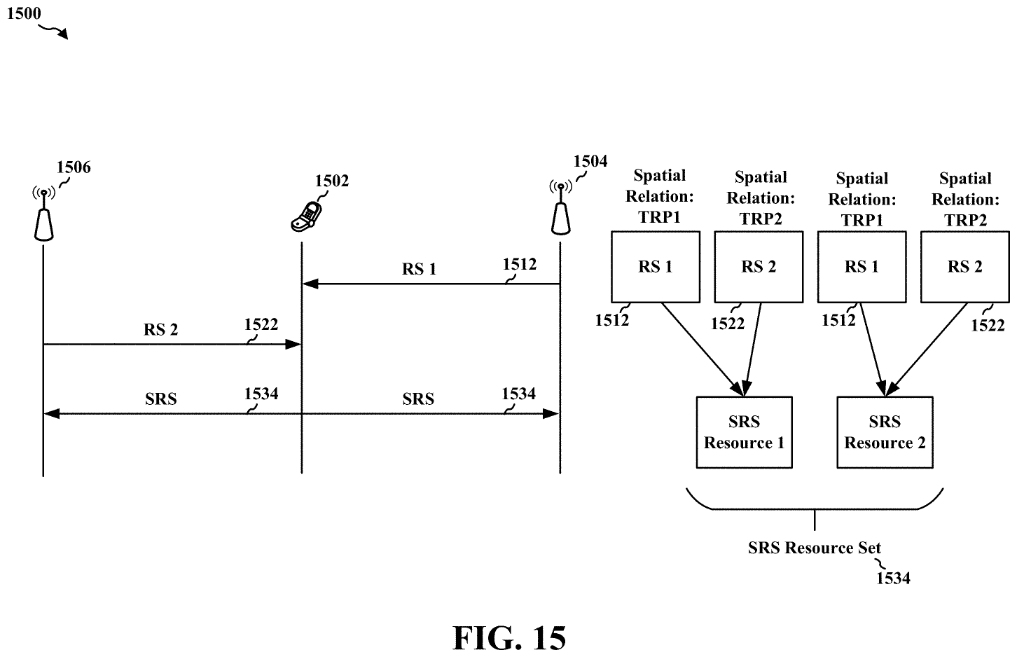

FIG. 15 is a communication flow diagram 1500 illustrating an SRS transmitted to multiple TRPs of an SFN on an SRS resource set. A UE 1502 may be connected to a first TRP 1504 and a second TRP 1506. The first TRP 1504 may transmit a first reference signal 1512 to the UE 1502. The second TRP 1506 may transmit a second reference signal 1522 to the UE 1502. In some aspects, the first reference signal 1512 and the second reference signal 1522 may be downlink reference signals. In some aspects, the first reference signal 1512 may be the first reference signal 512 described above with respect to FIG. 5, the first reference signal 612 described above with respect to FIG. 6, or the first reference signal 712 described above with respect to FIG. 7. In some aspects, the second reference signal 1522 may be the second reference signal 522 described above with respect to FIG. 5, the second reference signal 622 described above with respect to FIG. 6, or the second reference signal 722 described above with respect to FIG. 7.

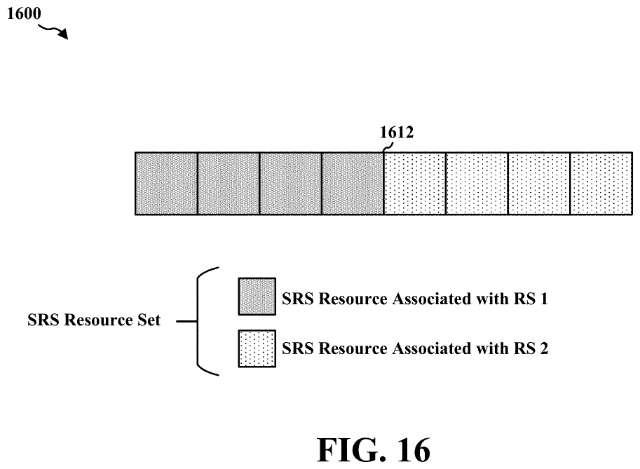

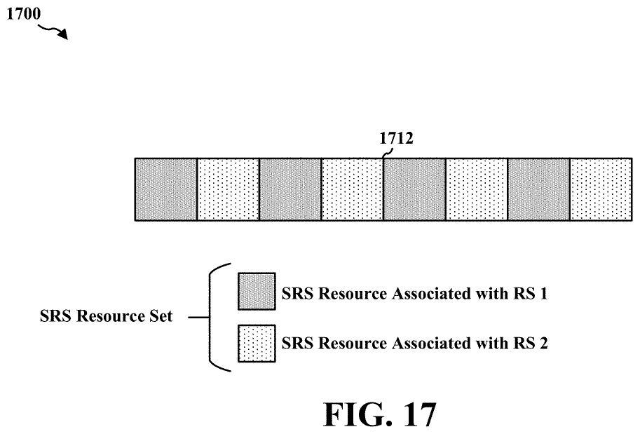

The UE 1502 may transmit an SRS 1534 to the first TRP 1504 and the second TRP 1506 on an SRS resource set. For example, the SRS resource set may be configured for non-codebook based transmission. The SRS resource set may include multiple SRS resources. In some aspects, the UE 1502 may transmit the SRS 1534 on a given SRS resource of the SRS resource set base on both the first reference signal 1512 and the second reference signal 1522. For example, the SRS resource set may include a first SRS resource and a second SRS resource. The UE 1502 may transmit the SRS 1534 using a beam corresponding to reception of the first reference signal 1512 on some symbols of the first SRS resource and using a beam corresponding to reception of the second reference signal 1522 on other symbols of the first SRS resource, and may transmit the SRS 1534 using a beam corresponding to reception of the first reference signal 1512 on some symbols of the second SRS resource and using a beam corresponding to reception of the second reference signal 1522 on other symbols of the second SRS resource. FIGS. 16 and 17 provide examples of the UE 1502 transmitting the SRS 1534 on a given SRS resource of the SRS resource set based on both the first reference signal 1512 and the second reference signal 1522.

FIG. 16 is a diagram 1600 illustrating symbols of an SRS resource 1612 of an SRS resource set. In the context of FIG. 15, the UE 1502 may transmit the SRS 1534 using a beam corresponding to reception of the first reference signal 1512 in a first set of adjacent symbols of the SRS resource 1612, and may transmit the SRS 1534 using a beam corresponding to reception of the second reference signal 1522 in a second set of adjacent symbols of the SRS resource 1612. For example, as illustrated in FIG. 16, the SRS resource 1612 may have eight symbols. The UE 1502 may transmit the SRS 1534 using the beam corresponding to reception of the first reference signal 1512 on the first four symbols, and may transmit the SRS 1534 using the beam corresponding to reception of the second reference signal 1522 on the second four symbols. The UE 1502 may do the same for each SRS resource in the SRS resource set.

FIG. 17 is a diagram 1700 illustrating symbols of an SRS resource 1712 of an SRS resource set. In some aspects, the UE 802 may transmit the SRS 1534 using a beam corresponding to reception of the first reference signal 1512 in a first set of nonadjacent symbols of the SRS resource 1712, and may transmit the SRS 1534 using a beam corresponding to reception of the second reference signal 1522 in a second set of nonadjacent symbols of the SRS resource 1712. The first set of symbols and the second symbols may be interleaved. For example, as illustrated in FIG. 17, the SRS resource 1712 may have eight symbols. The UE 1502 may transmit the SRS 1534 using the beam corresponding to reception of the first reference signal 812 on the first, third, fifth, and seventh symbols. The UE 1502 may transmit the SRS 1534 using the beam corresponding to reception of the second reference signal 1522 on the second, fourth, sixth, and eighth symbols. The UE 1502 may do the same for each SRS resource in the SRS resource set.

In some aspects, the way a UE transmits an SRS on an SRS resource set may be based on the usage configured for that SRS resource set. For example as described above, an SRS resource set may have a usage of codebook based transmission, non-codebook-based transmission, antenna switching, or beam management configured. In some aspects, when transmitting an SRS on an SRS resource set, the UE may determine if the usage for the SRS resource set is configured as non-codebook-based transmission. If the SRS resource set is configured as non-codebook-based transmission, the UE may transmit the SRS on the SRS resource set associated with multiple beams as described above with respect to FIG. 14 and/or FIG. 15. In some aspects, the UE may determine if the usage for the SRS resource set is configured as codebook based transmission. If the SRS resource set is configured as codebook based transmission, the UE may transmit the SRS on an SRS resource of the SRS resource set associated with multiple beams as described above with respect to FIG. 8. In some aspects, the UE may determine that the SRS resource set is both configured as codebook based transmission and that the SRS resource set contains only one SRS resource before transmitting the SRS as described above with respect to FIG. 8.

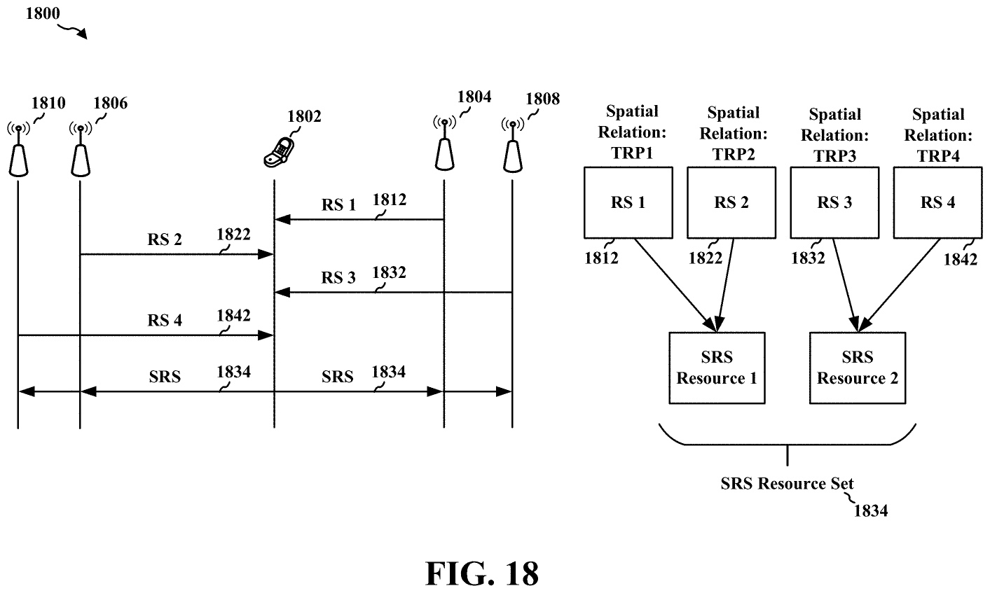

FIG. 18 is a communication flow diagram 1800 illustrating an SRS transmitted to multiple TRPs of an SFN on an SRS resource set. In some aspects, a UE may transmit an SRS on multiple SRS resources of an SRS resource set, and use different beams for each SRS resource. For example, a UE 1802 may be connected to a first TRP 1804, a second TRP 1806, a third TRP 1808, and a fourth TRP 1810. The first TRP 1804 may transmit a first reference signal 1812 to the UE 1802. The second TRP 1806 may transmit a second reference signal 1822 to the UE 1802. The third TRP 1808 may transmit a third reference signal 1832 to the UE 1802. The fourth TRP 1810 may transmit a fourth reference signal 1842 to the UE 1802. In some aspects, the first reference signal 1812, the second reference signal 1822, the third reference signal 1832, and the fourth reference signal 1842 may be downlink reference signals. In some aspects, the first reference signal 1812, the second reference signal 1822, the third reference signal 1832, and the fourth reference signal 1842 may correspond to the be the first reference signal 512 and the second reference signal 522 described above with respect to FIG. 5, the first reference signal 612 and the second reference signal 622 described above with respect to FIG. 6, and or the first reference signal 712 and the second reference signal 722 described above with respect to FIG. 7.

The UE 1802 may transmit an SRS 1834 to the first TRP 1804, the second TRP 1806, the third TRP 1808, and the fourth TRP 1810 on an SRS resource set. The SRS resource set may be configured for non-codebook based transmission. The SRS resource set may include a first SRS resource and a second SRS resource. The UE 1802 may transmit the SRS 1834 using a beam corresponding to reception of the first reference signal 1812 on some symbols of the first SRS resource and using a beam corresponding to reception of the second reference signal 1822 on other symbols of the first SRS resource. The UE 1802 may transmit the SRS 1834 using a beam corresponding to reception of the third reference signal 1832 on some symbols of the second SRS resource and using a beam corresponding to the fourth reference signal 1842 on other symbols of the second SRS resource.

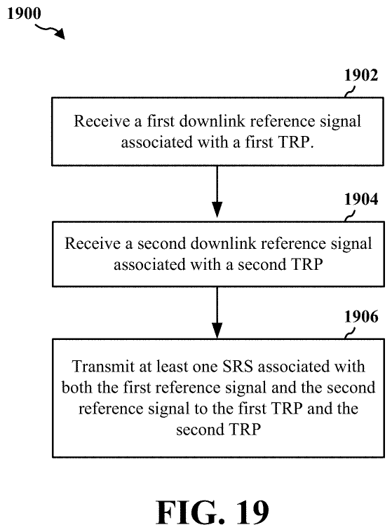

FIG. 19 is a flowchart 1900 of a method of wireless communication. The method may be performed by a UE (e.g., a UE 350, 402, 502, 602, 702, 802, 1402, 1502, or 1802) and/or other apparatus (e.g., the apparatus 2002). According to different aspects, one or more of the illustrated operations may be transposed, omitted, and/or contemporaneously performed.

At 1902, the UE may receive a first downlink reference signal associated with a first transmission reception point. In the context of FIG. 4, for example, the UE 402 may receive a first downlink reference signal from RRH0. In the context of FIGS. 5-8, for example, the UE 502, 602, 702, and/or 802 may receive a first downlink reference signal 512, 612, 712, and/or 812 from TRP 504, 604, 704, and/or 804. In the context of FIGS. 14, 15, and/or 18, for example, the UE 1402, 1502, and/or 1802 may receive a first downlink reference signal 1412, 1512, and/or 1812 from TRP 1404, 1504, and/or 1804.

At 1904, the UE may receive a second downlink reference signal associated with a second transmission reception point. In the context of FIG. 4, for example, the UE 402 may receive a second downlink reference signal from RRH1. In the context of FIGS. 5-8, for example, the UE 502, 602, 702, and/or 802 may receive a second downlink reference signal 522, 622, 722, and/or 822 from TRP 504, 604, 704, and/or 804. In the context of FIGS. 14, 15, and/or 18, for example, the UE 1402, 1502, and/or 1802 may receive a second downlink reference signal 1422, 1522, and/or 1822 from TRP 1404, 1504, and/or 1804.

At 1906, the UE may transmit, to the first transmission reception point and the second transmission reception point, at least one SRS that is associated with both the first downlink reference signal and the second downlink reference signal. In the context of FIG. 4, for example, the UE 402 may transmit, to RRH0 and RRH1, at least one SRS at least one SRS that is associated with both the first downlink reference signal and the second downlink reference signal. For example, in the context of FIG. 8, the UE 802 may transmit an SRS 834 to the first TRP 804 and the second TRP 806. The SRS 834 may be associated with the first reference signal 812 and the second reference signal 822. For example, the SRS 834 may have a TCI state containing the first reference signal 812 and a TCI state containing the second reference signal 822, or may have spatial relation information or associated CSI-RS indicators for both the first reference signal 812 and the second reference signal 822. For example, the UE 802 may transmit the SRS 834 using two spatial domain filters and/or two precoder configurations (e.g., two precoding matrices). The first beam may be based on the first reference signal 812, and the second beam may be based on the second reference signal 822.

In some aspects, the UE may transmit the SRS on a first port and on a second port the SRS in the same symbol. The first port may be transmitted with a beam or a precoder corresponding to reception of the first downlink reference signal, and the second port may be transmitted with a beam or precoder corresponding to reception of the second downlink reference signal.

In some aspects, the UE may transmit the SRS on a SRS resource. The SRS resource may include a first set of symbols and a second set of symbols different from the first set of symbols. The UE may transmit the SRS with a beam or a precoder corresponding to reception of the first downlink reference signal in the first set of symbols, and the UE may transmit the SRS with a beam or a precoder corresponding to reception of the second downlink reference signal in the second set of symbols. The first set of symbols may be consecutive symbols of the SRS resource and the second set of symbols may be consecutive symbols of the SRS resource. The first set of symbols may be interleaved with the second set of symbols.

In some further aspects, the UE may be capable of at least one of transmitting at least one SRS in the same symbol and/or respectively transmitting at least one SRS on at least two different sets of symbols. The UE may report such capability to the network (e.g., base station), such as in a UE capability message. The network (including by communicating with a set of TRPs) may configure communication with one or more TRPs according to the reported UE capabilities for SRS transmission, and/or the UE may indicate a preference of which of the reported UE capabilities the UE requests to use (assuming the UE is capable of both).

A first SRS resource may be in a slot i and a second SRS resource may be in a slot i+1. Each SRS resource may include a first set of symbols and a second set of symbols different from the first set of symbols. The UE may transmit the SRS with a beam or a precoder corresponding to reception of the first downlink reference signal in the first set of symbols of the first SRS resource, and the UE may transmit the SRS with a beam or a precoder corresponding to reception of the second downlink reference signal in the second set of symbols of the first SRS resource. The UE may transmit the SRS with the beam or the precoder corresponding to reception of the first downlink reference signal in the second set of symbols of the second SRS resource. The UE may transmit the SRS in the first set of symbols of the second SRS resource with the beam or the precoder corresponding to reception of the second downlink reference signal.

In some aspects, the UE may transmit the SRS on a SRS resource set. The SRS resource set may include a first SRS resource and a second SRS resource. The UE may transmit the SRS with a beam or a precoder corresponding to reception of the first downlink reference signal on the first SRS resource, and the UE may transmit the SRS with a beam or a precoder corresponding to reception of the second downlink reference signal on the second SRS resource.

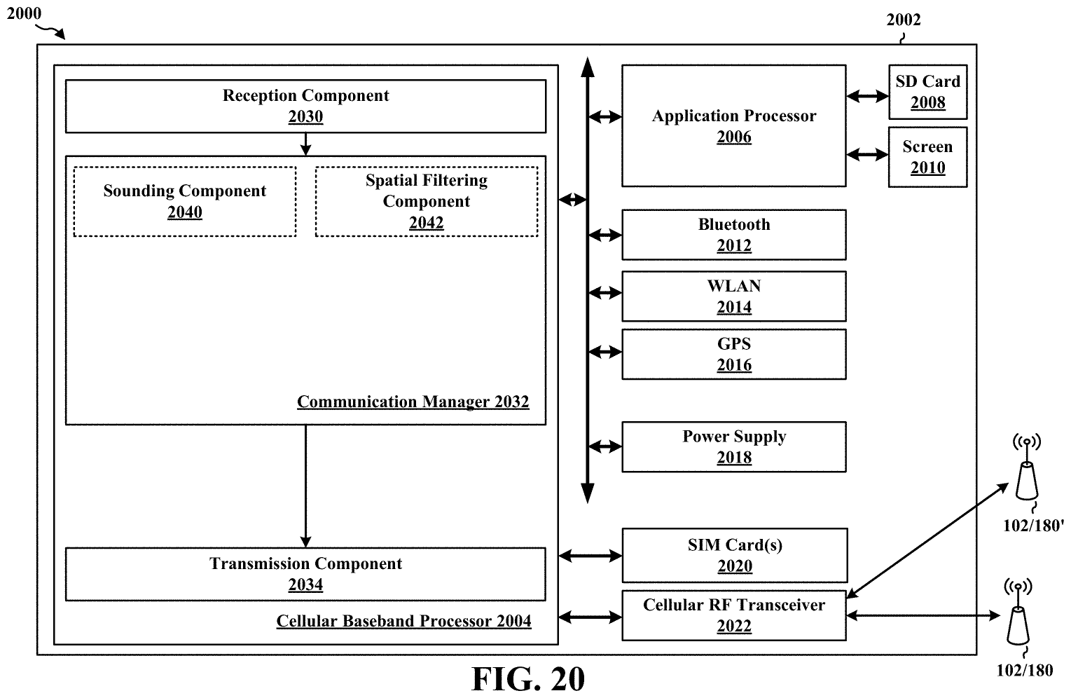

FIG. 20 is a diagram 2000 illustrating an example of a hardware implementation for an apparatus 2002. The apparatus 2002 is a UE (for example, the UE 350 with reference to FIG. 3) and includes a cellular baseband processor 2004 (also referred to as a modem) coupled to a cellular RF transceiver 2022 and one or more subscriber identity modules (SIM) cards 2020, an application processor 2006 coupled to a secure digital (SD) card 2008 and a screen 2010, a Bluetooth module 2012, a wireless local area network (WLAN) module 2014, a Global Positioning System (GPS) module 2016, and a power supply 2018. The cellular RF transceiver 2022 can correspond to at least one of the receiver 354RX and/or transmitter 354TX with reference to FIG. 3. The cellular baseband processor 2004 communicates through the cellular RF transceiver 2022 with the UE 104 and/or base station 102/180. The cellular baseband processor 2004 may include a computer-readable medium/memory. The computer-readable medium/memory may be non-transitory. The cellular baseband processor 2004 is responsible for general processing, including the execution of software stored on the computer-readable medium/memory. The software, when executed by the cellular baseband processor 2004, causes the cellular baseband processor 2004 to perform the various functions described supra. The computer-readable medium/memory may also be used for storing data that is manipulated by the cellular baseband processor 2004 when executing software. The cellular baseband processor 2004 further includes a reception component 2030, a communication manager 2032, and a transmission component 2034. The communication manager 2032 includes the one or more illustrated components. The components within the communication manager 2032 may be stored in the computer-readable medium/memory and/or configured as hardware within the cellular baseband processor 2004. The cellular baseband processor 2004 may be a component of the UE 350 and may include the memory 360 and/or at least one of the TX processor 368, the RX processor 356, and the controller/processor 359 with reference to FIG. 3. In one configuration, the apparatus 2002 may be a modem chip and include just the baseband processor 2004, and in another configuration, the apparatus 2002 may be the entire UE (e.g., the UE 350 of FIG. 3) and include the aforediscussed additional modules of the apparatus 2002.

The communication manager 2032 may include one or more of a sounding component 2040 and a spatial filtering component 2042. The communication manager 2032 may interface with the reception component 2030 and/or transmission component 2034, e.g., in order to respectively wirelessly receive and/or transmit data and/or control information from and/or a set of TRPs, which may include a first TRP 102/180 and a second TRP 102/180′.

The reception component 2030 may be configured to receive a first downlink reference signal associated with the first TRP 102/180, e.g., as described in connection with 1902 of FIG. 19.

The reception component 2030 may be further configured to receive a second downlink reference signal associated with the second TRP 102/180′, e.g., as described in connection with 1904 of FIG. 19.

The sounding component 2040 may be configured to generate at least one SRS for inclusion in at least one SRS resource (and/or SRS resource set), e.g., in association with reception of at least one of the first and/or second downlink reference signals. For example, the at least one SRS may be associated with at least one SRS resource that includes a set of consecutive symbols divided into a first set of symbols and a second set of symbols (the first and second sets of symbols may include the same number of symbols). In some aspects, each of the first set of symbols may be consecutive within one portion of the SRS resource, whereas each of the second set of symbols may be consecutive within another portion of the SRS resource. In some other aspects, the first and second sets of symbols may be at least partially interleaved (e.g., in the time domain) within the SRS resource.

The transmission component 2034 may be configured to transmit, to the first TRP 102/180 based on the first reference signal and the second TRP 102/180′ based on the second reference signal, at least one SRS on at least one SRS resource. For example, the at least one SRS may transmitted in at least a portion of a same symbol with a first spatial domain filter and/or a first precoding configuration corresponding to reception of the first downlink reference signal and with a second spatial domain filter and/or precoding configuration corresponding to reception of the second downlink reference signal.

The sounding component 2040 may map SRSs and resources thereof to symbols. In some aspects, the first set of symbols includes a first symbol and a third symbol of the at least one SRS resource, and the second set of symbols includes a second symbol and a fourth symbol of the at least one SRS resource. In some other aspects, the first set of symbols includes a first symbol, a second symbol, a fifth symbol, and a sixth symbol of the at least one SRS resource, and the second set of symbols includes a third symbol, a fourth symbol, a seventh symbol, and an eighth symbol of the at least one SRS resource.

The spatial filtering component 2042 may be configured to apply at least one spatial filter for transmission of the at least one SRS. For example, the spatial filtering component 2042 may apply a spatial domain filter and/or precoding configuration corresponding to reception of the first reference signal in the first set of symbols, and apply another spatial domain filter and/or precoding configuration corresponding to reception of the second downlink reference signal in the second set of symbols.

In some aspects, the sounding component 2040 may map SRSs and/or resources thereof such that at least one SRS resource at least partially occurs in each of slot i and slot i+1, the at least one SRS resource including a first set of symbols and a second set of symbols different from the first set of symbols in each slot, the at least one SRS is transmitted with a spatial domain filter and/or precoding configuration corresponding to reception of the first downlink reference signal in the first set of symbols of the at least one SRS resource in slot i, the at least one SRS is further transmitted with a spatial domain filter and/or precoding configuration corresponding to reception of the second downlink reference signal in the second set of symbols of the at least one SRS resource in slot i, and the at least one SRS is transmitted with the spatial domain filter and/or precoding configuration corresponding to reception of the first downlink reference signal in the second set of symbols of the at least one SRS resource in slot i+1. For example, the at least one SRS may be transmitted with the spatial domain filter and/or precoding configuration corresponding to reception of the second downlink reference signal in the first set of symbols of the at least one SRS resource in slot i+1.

In some aspects, the at least one SRS may be transmitted on an SRS resource of an SRS resource set, with the at least one SRS resource set being associated with codebook-based transmission. The at least one SRS may be transmitted with the at least one SRS resource being associated with both the first downlink reference signal and the second downlink reference signal when the at least one SRS resource set is associated with codebook-based transmission.

In some other aspects, the at least one SRS may be transmitted on an SRS resource of an SRS resource set associated with codebook-based transmission and having less than two SRS resources, and the at least one SRS may be transmitted with the at least one SRS resource being associated with both the first downlink reference signal and the second downlink reference signal when the at least one SRS resource set is associated with codebook-based transmission and when that the at least one SRS resource set has less than two SRS resources.

In still other aspects, the at least one SRS is transmitted on an SRS resource set, the at least one SRS resource set includes a first SRS resource and a second SRS resource, the at least one SRS is transmitted with a spatial domain filter and/or precoding configuration corresponding to reception of the first downlink reference signal on the first SRS resource, and the at least one SRS may be transmitted with a spatial domain filter and/or precoding configuration corresponding to reception of the second downlink reference signal on the second SRS resource.

In still other aspects, the at least one SRS resource set is associated with non-codebook-based transmission, the at least one SRS corresponding to reception of the first downlink reference signal is transmitted on the first SRS resource and the at least one SRS corresponding to reception of the second downlink reference signal is transmitted on the second SRS resource when the at least one SRS resource set is associated with non-codebook-based transmission.

In some aspects, the at least one SRS is transmitted on an SRS resource set, the at least one SRS resource set includes a first SRS resource and a second SRS resource, each SRS resource including a first set of symbols and a second set of symbols, the at least one SRS is transmitted with a spatial domain filter and/or precoding configuration corresponding to reception of the first downlink reference signal in the first set of symbols of the first SRS resource and in the first set of symbols of the second SRS resource, and the at least one SRS is transmitted with a spatial domain filter and/or precoding configuration corresponding to reception of the second downlink reference signal in the second set of symbols of the first SRS resource and in the second set of symbols of the second SRS resource.

Potentially, the reception component 2030 may be further configured to receive a third downlink reference signal associated with a third TRP, the at least one SRS being transmitted on an SRS resource set including a first SRS resource and a second SRS resource that each includes a first set of symbols and a second set of symbols, the at least one SRS being transmitted with a spatial domain filter and/or precoding configuration corresponding to reception of the first downlink reference signal in the first set of symbols of the first SRS resource, the at least one SRS being transmitted with a spatial domain filter and/or precoding configuration corresponding to reception of the second downlink reference signal in the second set of symbols of the first SRS resource, and the at least one SRS with a spatial domain filter and/or precoding configuration corresponding to reception of the third downlink reference signal in the first set of symbols of the second SRS resource.

The apparatus 2002 may include additional components that perform some or all of the blocks, operations, signaling, etc. of the algorithm(s) in the aforementioned call flow diagrams and/or flowchart of FIGS. 5-8, 14, 15, 18, and/or 19. As such, some or all of the blocks, operations, signaling, etc. in the aforementioned call flow diagrams and/or flowchart of FIGS. 5-8, 14, 15, 18, and/or 19 may be performed by a component and the apparatus 2002 may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 2002, and in particular the cellular baseband processor 2004, includes means for receiving a first downlink reference signal associated with a first TRP; means for receiving a second downlink reference signal associated with a second TRP; and means for transmitting, to the first TRP and the second TRP, at least one SRS that is associated with both the first downlink reference signal and the second downlink reference signal.

In one configuration, the at least one SRS is transmitted in at least a portion of a same symbol, the at least one SRS being transmitted with a first spatial domain filter and/or precoding configuration corresponding to reception of the first downlink reference signal and being further transmitted with a second spatial domain filter and/or precoding configuration corresponding to reception of the second downlink reference signal.

In one configuration, the at least one SRS is associated with at least one SRS resource, the at least one SRS resource includes a set of consecutive symbols, the set of consecutive symbols including a first set of symbols and a second set of symbols different from the first set of symbols, the at least one SRS is transmitted with a spatial domain filter and/or precoding configuration corresponding to reception of the first downlink reference signal in the first set of symbols, and the at least one SRS is transmitted with a spatial domain filter and/or precoding configuration corresponding to reception of the second downlink reference signal in the second set of symbols.

In one configuration, the first set of symbols and the second set of symbols have a same number of symbols.

In one configuration, the first set of symbols includes one or more symbols that are consecutive in the at least one SRS resource, and the second set of symbols includes one or more other symbols that are consecutive in the at least one SRS resource.

In one configuration, the first set of symbols are time-domain interleaved with the second set of symbols.

In one configuration, the first set of symbols includes a first symbol and a third symbol of the at least one SRS resource, and the second set of symbols includes a second symbol and a fourth symbol of the at least one SRS resource.

In one configuration, the first set of symbols includes a first symbol, a second symbol, a fifth symbol, and a sixth symbol of the at least one SRS resource, and the second set of symbols includes a third symbol, a fourth symbol, a seventh symbol, and an eighth symbol of the at least one SRS resource.

In one configuration, at least one SRS resource at least partially occurs in each of slot i and slot i+1, the at least one SRS resource including a first set of symbols and a second set of symbols different from the first set of symbols in each slot, the at least one SRS is transmitted with a spatial domain filter and/or precoding configuration corresponding to reception of the first downlink reference signal in the first set of symbols of the at least one SRS resource in slot i, the at least one SRS is further transmitted with a spatial domain filter and/or precoding configuration corresponding to reception of the second downlink reference signal in the second set of symbols of the at least one SRS resource in slot i, and the at least one SRS is transmitted with the spatial domain filter and/or precoding configuration corresponding to reception of the first downlink reference signal in the second set of symbols of the at least one SRS resource in slot i+1.

In one configuration, the at least one SRS is transmitted with the spatial domain filter and/or precoding configuration corresponding to reception of the second downlink reference signal in the first set of symbols of the at least one SRS resource in slot i+1.

In one configuration, the at least one SRS is transmitted on an SRS resource of an SRS resource set, the at least one SRS resource set being associated with codebook-based transmission, and the at least one SRS is transmitted with the at least one SRS resource being associated with both the first downlink reference signal and the second downlink reference signal when the at least one SRS resource set is associated with codebook-based transmission.

In one configuration, the at least one SRS is transmitted on an SRS resource of an SRS resource set associated with codebook-based transmission and having less than two SRS resources, and the at least one SRS is transmitted with the at least one SRS resource being associated with both the first downlink reference signal and the second downlink reference signal when the at least one SRS resource set is associated with codebook-based transmission and when that the at least one SRS resource set has less than two SRS resources.

In one configuration, the at least one SRS is transmitted on an SRS resource set, the at least one SRS resource set includes a first SRS resource and a second SRS resource, the at least one SRS is transmitted with a spatial domain filter and/or precoding configuration corresponding to reception of the first downlink reference signal on the first SRS resource, and the at least one SRS is transmitted with a spatial domain filter and/or precoding configuration corresponding to reception of the second downlink reference signal on the second SRS resource.

In one configuration, the at least one SRS resource set is associated with non-codebook-based transmission, and the at least one SRS corresponding to reception of the first downlink reference signal is transmitted on the first SRS resource and the at least one SRS corresponding to reception of the second downlink reference signal is transmitted on the second SRS resource when the at least one SRS resource set is associated with non-codebook-based transmission.

In one configuration, the at least one SRS is transmitted on an SRS resource set, the at least one SRS resource set includes a first SRS resource and a second SRS resource, each SRS resource including a first set of symbols and a second set of symbols, the at least one SRS is transmitted with a spatial domain filter and/or precoding configuration corresponding to reception of the first downlink reference signal in the first set of symbols of the first SRS resource and in the first set of symbols of the second SRS resource, and the at least one SRS is transmitted with a spatial domain filter and/or precoding configuration corresponding to reception of the second downlink reference signal in the second set of symbols of the first SRS resource and in the second set of symbols of the second SRS resource.

In one configuration, the apparatus 2002, and in particular the cellular baseband processor 2004, may further include means for receiving a third downlink reference signal associated with a third TRP, the at least one SRS being transmitted on an SRS resource set including a first SRS resource and a second SRS resource that each includes a first set of symbols and a second set of symbols, the at least one SRS being transmitted with a spatial domain filter and/or precoding configuration corresponding to reception of the first downlink reference signal in the first set of symbols of the first SRS resource, the at least one SRS being transmitted with a spatial domain filter and/or precoding configuration corresponding to reception of the second downlink reference signal in the second set of symbols of the first SRS resource, and the at least one SRS with a spatial domain filter and/or precoding configuration corresponding to reception of the third downlink reference signal in the first set of symbols of the second SRS resource.

The aforementioned means may be one or more of the aforementioned components of the apparatus 2002 configured to perform the functions recited by the aforementioned means. As described supra, the apparatus 2002 may include the TX Processor 368, the RX Processor 356, and the controller/processor 359. As such, in one configuration, the aforementioned means may be the TX Processor 368, the RX Processor 356, and the controller/processor 359 configured to perform the functions recited by the aforementioned means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The following examples are illustrative only and may be combined with aspects of other embodiments or teachings described herein, without limitation.

Example 1 may be an apparatus for wireless communication by a UE, configured to: receive a first downlink reference signal associated with a first TRP; receive a second downlink reference signal associated with a second TRP; and transmit, to the first TRP and the second TRP, at least one SRS that is associated with both the first downlink reference signal and the second downlink reference signal.

Example 2 may be the apparatus of Example 1, and the at least one SRS is transmitted in a first symbol with at least one of a first spatial domain filter or a first precoding configuration corresponding to reception of the first downlink reference signal, and the at least one SRS is further transmitted in the first symbol with at least one of a second spatial domain filter or a second precoding configuration corresponding to reception of the second downlink reference signal.

Example 3 may be the apparatus of Example 1, and: the at least one SRS is associated with at least one SRS resource comprising a first set of symbols and a second set of symbols, the at least one SRS is transmitted in the first set of symbols using at least one of a first spatial domain filter or a first precoding configuration corresponding to reception of the first downlink reference signal, and the at least one SRS is transmitted in the second set of symbols using at least one of a second spatial domain filter or a second precoding configuration corresponding to reception of the second downlink reference signal.

Example 4 may be the apparatus of Example 3, and the first set of symbols and the second set of symbols have a same number of symbols.

Example 5 may be the apparatus of Example 3, and the first set of symbols comprises one or more symbols that are consecutive, and the second set of symbols comprises one or more other symbols that are consecutive.

Example 6 may be the apparatus of Example 3, and the first set of symbols are time-domain interleaved with the second set of symbols.

Example 7 may be the apparatus of Example 1, and: at least one SRS resource at least partially occurs in each of slot i and slot i+1, the at least one SRS resource comprising a first set of symbols and a second set of symbols different from the first set of symbols in each slot, the at least one SRS is transmitted using at least one of a first spatial domain filter or a first precoding configuration corresponding to reception of the first downlink reference signal in the first set of symbols of the at least one SRS resource in slot i, the at least one SRS is further transmitted using at least one of a second spatial domain filter or a second precoding configuration corresponding to reception of the second downlink reference signal in the second set of symbols of the at least one SRS resource in slot i, and the at least one SRS is transmitted using the at least one of the first spatial domain filter or the first precoding configuration in the second set of symbols of the at least one SRS resource in slot i+1.

Example 8 may be the apparatus of Example 7, and the at least one SRS is transmitted using the at least one of the second spatial domain filter or the second precoding configuration in the first set of symbols of the at least one SRS resource in slot i+1.

Example 9 may be the apparatus of Example 1, and the at least one SRS is transmitted on at least one SRS resource of an SRS resource set associated with codebook-based transmission, and the at least one SRS resource is associated with both the first downlink reference signal and the second downlink reference signal.

Example 10 may be the apparatus of Example 1, and: the at least one SRS is transmitted on a first SRS resource of an SRS resource set using at least one of a first spatial domain filter or a first precoding configuration corresponding to reception of the first downlink reference signal, and the at least one SRS is transmitted on a second SRS resource of the SRS resource set using at least one of a second spatial domain filter or a second precoding configuration corresponding to reception of the second downlink reference signal.

Example 11 may be the apparatus of Example 10, and transmission of the at least one SRS resource on the first SRS resource and the second SRS resource of the at least one SRS resource set is configured to be non-codebook-based.

Example 12 may be the apparatus of Example 1, and: the at least one SRS is associated with an SRS resource set comprising a first SRS resource and a second SRS resource that each includes a first set of symbols and a second set of symbols, the at least one SRS is transmitted on both the first set of symbols of the first SRS resource and in the first set of symbols of the second SRS resource using at least one of a first spatial domain filter or a first precoding configuration corresponding to reception of the first downlink reference signal, and the at least one SRS is transmitted on both the second set of symbols of the first SRS resource and in the second set of symbols of the second SRS resource using at least one of a second spatial domain filter or a second precoding configuration corresponding to reception of the second downlink reference signal.

Example 13 may be the apparatus of Example 1, and further configured to: receive a third downlink reference signal associated with a third transmission reception point, and the at least one SRS is transmitted on an SRS resource of an SRS resource set using at least one of a first spatial domain filter or a first precoding configuration corresponding to reception of the first downlink reference signal, the at least one SRS is further transmitted on the SRS resource using at least one of a second spatial domain filter or a second precoding configuration corresponding to reception of the second downlink reference signal, and the at least one SRS is further transmitted on another SRS resource of the SRS resource set using at least one of a third spatial domain filter or a third precoding configuration corresponding to reception of the third downlink reference signal.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method of wireless communication by a user equipment (UE), comprising:
receiving a first downlink reference signal associated with a first transmission reception point;
receiving a second downlink reference signal associated with a second transmission reception point; and
transmitting, to the first transmission reception point and the second transmission reception point, at least one sounding reference signal (SRS) that is associated with both the first downlink reference signal and the second downlink reference signal.

2. The method of claim 1, wherein the at least one SRS is transmitted in a first symbol with at least one of a first spatial domain filter or a first precoding configuration corresponding to reception of the first downlink reference signal, and the at least one SRS is further transmitted in the first symbol with at least one of a second spatial domain filter or a second precoding configuration corresponding to reception of the second downlink reference signal.

3. The method of claim 1, wherein:
the at least one SRS is associated with at least one SRS resource comprising a first set of symbols and a second set of symbols,
the at least one SRS is transmitted in the first set of symbols using at least one of a first spatial domain filter or a first precoding configuration corresponding to reception of the first downlink reference signal, and
the at least one SRS is transmitted in the second set of symbols using at least one of a second spatial domain filter or a second precoding configuration corresponding to reception of the second downlink reference signal.

4. The method of claim 3, wherein the first set of symbols and the second set of symbols have a same number of symbols.

5. The method of claim 3, wherein the first set of symbols comprises one or more symbols that are consecutive, and the second set of symbols comprises one or more other symbols that are consecutive.

6. The method of claim 3, wherein the first set of symbols are time-domain interleaved with the second set of symbols.

7. The method of claim 1, wherein:
at least one SRS resource at least partially occurs in each of slot i and slot i+1, the at least one SRS resource comprising a first set of symbols and a second set of symbols different from the first set of symbols in each slot,
the at least one SRS is transmitted using at least one of a first spatial domain filter or a first precoding configuration corresponding to reception of the first downlink reference signal in the first set of symbols of the at least one SRS resource in slot i,
the at least one SRS is further transmitted using at least one of a second spatial domain filter or a second precoding configuration corresponding to reception of the second downlink reference signal in the second set of symbols of the at least one SRS resource in slot i, and
the at least one SRS is transmitted using the at least one of the first spatial domain filter or the first precoding configuration in the second set of symbols of the at least one SRS resource in slot i+1.

8. The method of claim 7, wherein the at least one SRS is transmitted using the at least one of the second spatial domain filter or the second precoding configuration in the first set of symbols of the at least one SRS resource in slot i+1.

9. The method of claim 1, wherein the at least one SRS is transmitted on at least one SRS resource of an SRS resource set associated with codebook-based transmission, and the at least one SRS resource is associated with both the first downlink reference signal and the second downlink reference signal.

10. The method of claim 1, wherein:
the at least one SRS is transmitted on a first SRS resource of an SRS resource set using at least one of a first spatial domain filter or a first precoding configuration corresponding to reception of the first downlink reference signal, and
the at least one SRS is transmitted on a second SRS resource of the SRS resource set using at least one of a second spatial domain filter or a second precoding configuration corresponding to reception of the second downlink reference signal.

11. The method of claim 10, wherein transmission of the at least one SRS resource on the first SRS resource and the second SRS resource of the at least one SRS resource set is configured to be non-codebook-based.

12. The method of claim 1, wherein:
the at least one SRS is associated with an SRS resource set comprising a first SRS resource and a second SRS resource that each includes a first set of symbols and a second set of symbols,
the at least one SRS is transmitted on both the first set of symbols of the first SRS resource and in the first set of symbols of the second SRS resource using at least one of a first spatial domain filter or a first precoding configuration corresponding to reception of the first downlink reference signal, and
the at least one SRS is transmitted on both the second set of symbols of the first SRS resource and in the second set of symbols of the second SRS resource using at least one of a second spatial domain filter or a second precoding configuration corresponding to reception of the second downlink reference signal.

13. The method of claim 1, further comprising:
receiving a third downlink reference signal associated with a third transmission reception point, wherein
the at least one SRS is transmitted on an SRS resource of an SRS resource set using at least one of a first spatial domain filter or a first precoding configuration corresponding to reception of the first downlink reference signal,
the at least one SRS is further transmitted on the SRS resource using at least one of a second spatial domain filter or a second precoding configuration corresponding to reception of the second downlink reference signal, and
the at least one SRS is further transmitted on another SRS resource of the SRS resource set using at least one of a third spatial domain filter or a third precoding configuration corresponding to reception of the third downlink reference signal.

14. An apparatus for wireless communication, comprising:
a memory; and
at least one processor coupled to the memory and configured to:
receive a first downlink reference signal associated with a first transmission reception point;
receive a second downlink reference signal associated with a second transmission reception point; and
transmit, to the first transmission reception point and the second transmission reception point, at least one sounding reference signal (SRS) that is associated with both the first downlink reference signal and the second downlink reference signal.

15. The apparatus of claim 14, wherein the at least one SRS is transmitted in a first symbol with at least one of a first spatial domain filter or a first precoding configuration corresponding to reception of the first downlink reference signal, and the at least one SRS is further transmitted in the first symbol with at least one of a second spatial domain filter or a second precoding configuration corresponding to reception of the second downlink reference signal.

16. The apparatus of claim 14, wherein:
the at least one SRS is associated with at least one SRS resource comprising a first set of symbols and a second set of symbols,
the at least one SRS is transmitted in the first set of symbols using at least one of a first spatial domain filter or a first precoding configuration corresponding to reception of the first downlink reference signal, and
the at least one SRS is transmitted in the second set of symbols using at least one of a second spatial domain filter or a second precoding configuration corresponding to reception of the second downlink reference signal.

17. The apparatus of claim 16, wherein the first set of symbols and the second set of symbols have a same number of symbols.

18. The apparatus of claim 16, wherein the first set of symbols comprises one or more symbols that are consecutive, and the second set of symbols comprises one or more other symbols that are consecutive.

19. The apparatus of claim 16, wherein the first set of symbols are time-domain interleaved with the second set of symbols.

20. The apparatus of claim 14, wherein:
at least one SRS resource at least partially occurs in each of slot i and slot i+1, the at least one SRS resource comprising a first set of symbols and a second set of symbols different from the first set of symbols in each slot,
the at least one SRS is transmitted using at least one of a first spatial domain filter or a first precoding configuration corresponding to reception of the first downlink reference signal in the first set of symbols of the at least one SRS resource in slot i,
the at least one SRS is further transmitted using at least one of a second spatial domain filter or a second precoding configuration corresponding to reception of the second downlink reference signal in the second set of symbols of the at least one SRS resource in slot i, and
the at least one SRS is transmitted using the at least one of the first spatial domain filter or the first precoding configuration in the second set of symbols of the at least one SRS resource in slot i+1.

21. The apparatus of claim 20, wherein the at least one SRS is transmitted using the at least one of the second spatial domain filter or the second precoding configuration in the first set of symbols of the at least one SRS resource in slot i+1.

22. The apparatus of claim 14, wherein the at least one SRS is transmitted on at least one SRS resource of an SRS resource set associated with codebook-based transmission, and the at least one SRS resource is associated with both the first downlink reference signal and the second downlink reference signal.

23. The apparatus of claim 14, wherein:
the at least one SRS is transmitted on a first SRS resource of an SRS resource set using at least one of a first spatial domain filter or a first precoding configuration corresponding to reception of the first downlink reference signal, and
the at least one SRS is transmitted on a second SRS resource of the SRS resource set using at least one of a second spatial domain filter or a second precoding configuration corresponding to reception of the second downlink reference signal.

24. The apparatus of claim 23, wherein transmission of the at least one SRS resource on the first SRS resource and the second SRS resource of the at least one SRS resource set is configured to be non-codebook-based.

25. The apparatus of claim 14, wherein:
the at least one SRS is associated with an SRS resource set comprising a first SRS resource and a second SRS resource that each includes a first set of symbols and a second set of symbols,
the at least one SRS is transmitted on both the first set of symbols of the first SRS resource and in the first set of symbols of the second SRS resource using at least one of a first spatial domain filter or a first precoding configuration corresponding to reception of the first downlink reference signal, and
the at least one SRS is transmitted on both the second set of symbols of the first SRS resource and in the second set of symbols of the second SRS resource using at least one of a second spatial domain filter or a second precoding configuration corresponding to reception of the second downlink reference signal.

26. The apparatus of claim 14, wherein the at least one processor is further configured to:
receive a third downlink reference signal associated with a third transmission reception point, wherein
the at least one SRS is transmitted on an SRS resource of an SRS resource set using at least one of a first spatial domain filter or a first precoding configuration corresponding to reception of the first downlink reference signal,
the at least one SRS is further transmitted on the SRS resource using at least one of a second spatial domain filter or a second precoding configuration corresponding to reception of the second downlink reference signal, and
the at least one SRS is further transmitted on another SRS resource of the SRS resource set using at least one of a third spatial domain filter or a third precoding configuration corresponding to reception of the third downlink reference signal.

27. An apparatus for wireless communication by a user equipment (UE), comprising:
means for receiving a first downlink reference signal associated with a first transmission reception point;
means for receiving a second downlink reference signal associated with a second transmission reception point; and
means for transmitting, to the first transmission reception point and the second transmission reception point, at least one sounding reference signal (SRS) that is associated with both the first downlink reference signal and the second downlink reference signal.

28. The apparatus of claim 27, wherein the at least one SRS is transmitted in a first symbol with at least one of a first spatial domain filter or a first precoding configuration corresponding to reception of the first downlink reference signal, and the at least one SRS is further transmitted in the first symbol with at least one of a second spatial domain filter or a second precoding configuration corresponding to reception of the second downlink reference signal.

29. The apparatus of claim 27, wherein:
the at least one SRS is associated with at least one SRS resource comprising a first set of symbols and a second set of symbols,
the at least one SRS is transmitted in the first set of symbols using at least one of a first spatial domain filter or a first precoding configuration corresponding to reception of the first downlink reference signal, and
the at least one SRS is transmitted in the second set of symbols using at least one of a second spatial domain filter or a second precoding configuration corresponding to reception of the second downlink reference signal.

30. The apparatus of claim 29, wherein the first set of symbols and the second set of symbols have a same number of symbols.

31. The apparatus of claim 29, wherein the first set of symbols comprises one or more symbols that are consecutive, and the second set of symbols comprises one or more other symbols that are consecutive.

32. The apparatus of claim 29, wherein the first set of symbols are time-domain interleaved with the second set of symbols.

33. The apparatus of claim 27, wherein:
at least one SRS resource at least partially occurs in each of slot i and slot i+1, the at least one SRS resource comprising a first set of symbols and a second set of symbols different from the first set of symbols in each slot,
the at least one SRS is transmitted using at least one of a first spatial domain filter or a first precoding configuration corresponding to reception of the first downlink reference signal in the first set of symbols of the at least one SRS resource in slot i,
the at least one SRS is further transmitted using at least one of a second spatial domain filter or a second precoding configuration corresponding to reception of the second downlink reference signal in the second set of symbols of the at least one SRS resource in slot i, and
the at least one SRS is transmitted using the at least one of the first spatial domain filter or the first precoding configuration in the second set of symbols of the at least one SRS resource in slot i+1.

34. The apparatus of claim 33, wherein the at least one SRS is transmitted using the at least one of the second spatial domain filter or the second precoding configuration in the first set of symbols of the at least one SRS resource in slot i+1.

35. The apparatus of claim 27, wherein the at least one SRS is transmitted on at least one SRS resource of an SRS resource set associated with codebook-based transmission, and the at least one SRS resource is associated with both the first downlink reference signal and the second downlink reference signal.

36. The apparatus of claim 27, wherein:
the at least one SRS is transmitted on a first SRS resource of an SRS resource set using at least one of a first spatial domain filter or a first precoding configuration corresponding to reception of the first downlink reference signal, and
the at least one SRS is transmitted on a second SRS resource of the SRS resource set using at least one of a second spatial domain filter or a second precoding configuration corresponding to reception of the second downlink reference signal.

37. The apparatus of claim 36, wherein transmission of the at least one SRS resource on the first SRS resource and the second SRS resource of the at least one SRS resource set is configured to be non-codebook-based.

38. The apparatus of claim 27, wherein:
the at least one SRS is associated with an SRS resource set comprising a first SRS resource and a second SRS resource that each includes a first set of symbols and a second set of symbols,
the at least one SRS is transmitted on both the first set of symbols of the first SRS resource and in the first set of symbols of the second SRS resource using at least one of a first spatial domain filter or a first precoding configuration corresponding to reception of the first downlink reference signal, and
the at least one SRS is transmitted on both the second set of symbols of the first SRS resource and in the second set of symbols of the second SRS resource using at least one of a second spatial domain filter or a second precoding configuration corresponding to reception of the second downlink reference signal.

39. The apparatus of claim 27, further comprising:
means for receiving a third downlink reference signal associated with a third transmission reception point, wherein
the at least one SRS is transmitted on an SRS resource of an SRS resource set using at least one of a first spatial domain filter or a first precoding configuration corresponding to reception of the first downlink reference signal,
the at least one SRS is further transmitted on the SRS resource using at least one of a second spatial domain filter or a second precoding configuration corresponding to reception of the second downlink reference signal, and
the at least one SRS is further transmitted on another SRS resource of the SRS resource set using at least one of a third spatial domain filter or a third precoding configuration corresponding to reception of the third downlink reference signal.

40. A computer-readable medium storing computer-executable code for wireless communication by a user equipment (UE), the code when executed by a processor cause the processor to:
receive a first downlink reference signal associated with a first transmission reception point;
receive a second downlink reference signal associated with a second transmission reception point; and
transmit, to the first transmission reception point and the second transmission reception point, at least one sounding reference signal (SRS) that is associated with both the first downlink reference signal and the second downlink reference signal.
